(19) United States
(12) Patent Application Publication
(10) Pub. No.: US 2016/0198749 A1
(43) Pub. Date: Jul. 14, 2016

(54) SWEETENER COMPOSITIONS

(71) Applicant: Tate & Lyle Ingredients Americas LLC, Hoffman Estates, IL (US)

(72) Inventors: Joshua Nehemiah FLETCHER, Hoffman Estates, IL (US); Jason C. COHEN, Hoffman Estates, IL (US); Adrienne Stucky POHRTE, Hoffman Estates, IL (US)

(73) Assignee: Tate & Lyle Ingredients Americas LLC, Hoffman Estates, IL (US)

(21) Appl. No.: 14/909,351

(22) PCT Filed: Jul. 31, 2014
(86) PCT No.: PCT/GB2014/052345

§ 371 Date: Feb. 1, 2016

Related U.S. Application Data
(60) Provisional application No. 61/861,780, filed on Aug. 2, 2013.

(51) Int. Cl. A23L 1/10; A23L 2/60; A23L 1/236

(52) U.S. Cl. CPC A23L 1/2363; A23L 2/60; A23L 1/22091; A23V 2002/00

(57) ABSTRACT

A sweetener composition comprising: at least one high potency sweetener; and at least one anti-foaming agent, wherein the at least one high potency sweetener contains hydrophilic and hydrophobic structural moieties.

### FIELD OF THE INVENTION

The present invention relates to improving the taste of high potency sweeteners and products sweetened with the same. In particular, the present invention relates to the use of anti-foaming agents to improve the taste of high potency sweeteners and provide a more sugar-like temporal profile by reducing the delay in sweetness onset and/or reducing the sweetness linger of the sweetener. The present invention further relates to a composition and products comprising the combination of an anti-foaming agent and a high potency sweetener having a beneficial temporal profile.

### BACKGROUND OF THE INVENTION

Although desirable in terms of taste, excess intake of high calorie sugars, such as sucrose (table sugar), has long been associated with an increase in diet-related health issues, such as obesity. This worrying trend has caused consumers to become increasingly aware of the importance of adopting a healthier lifestyle and reducing the level of high calorie sugars in their diet.

In recent years, there has been a movement towards the development of substitutes for high calorie sugars, with a particular focus on the development of low or zero-calorie sweeteners. An ideal replacement for a high calorie sugar would be a sweetener that has the same desirable taste characteristics, feel and temporal profile as sucrose, but which also has low or no calories. Aiming to meet this growing need, the market has been flooded with possible candidates for a sugar replacement. Unfortunately, however, many of the low or zero calorie sugar substitutes offered on the market lack one or all of the necessary characteristics, and often exhibit bitterness or off-taste. Therefore, many of the proposed sugar substitutes available are not an ideal replacement for high calorie sugars.

The present invention seeks to provide an improved sweetener composition that can be used in a variety of products and overcomes the temporal profile issues discussed above.

### SUMMARY OF THE INVENTION

A first aspect of the invention provides a sweetener composition comprising at least one high potency sweetener; and at least one anti-foaming agent, wherein the at least one high potency sweetener contains hydrophilic and hydrophobic structural moieties.

In embodiments of the invention, the at least one high potency sweetener is selected from the group consisting of a natural high potency sweetener, a synthetic high potency sweetener that is a glycoside, or a synthetic high potency sweetener that is derived from an amino acid.

In embodiments of the invention, the at least one high potency sweetener in the sweetener composition is selected from the group consisting of alitame, brazzein, curculin, hernandulcin, N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L-[alpha]-aspartyl]-L-phenylalanine 1-methyl ester, mabinlin, N-[N-[3-(3-methoxy-4-hydroxyphenyl)propyl]-L-[alpha]-aspartyl]-L-phenylalanine 1-methyl ester, monellin, phyllodulcin and thaumatin; particularly abrusoside A, aspartame, baiyunoside, cyclocarioside I, glycyphyllin, glycyrrhizic acid, monatin, mukurozioside, osladin, periandrins, phlomisosides, phloridzin, polypodoside A, pterocaryoside A, pterocaryoside B, and trilobatin; more particularly neohesperidin dihydrochalcone and neotame; and yet more particularly a Luo Han Guo extract and/or an ent-kaurane sweetener (e.g. a stevia extract, steviol glycosides, glucosylated steviol glycosides, rubusoside, or a rebaudioside, such as rebaudioside A to F, M, N and X); and salts and/or solvates thereof. In an embodiment, the high potency sweetener is a Luo Han Guo extract. In a further embodiment, the high potency sweetener is an ent-kaurane sweetener (e.g. a stevia extract, glucosylated steviol glycosides, rubusoside, steviol glycosides, or a rebaudioside such as rebaudioside A to F, M, N and X). In yet a further embodiment, the high potency sweetener is a blend of a Luo Han Guo extract and an ent-kaurane sweetener (e.g. a stevia extract, glucosylated steviol glycosides, rubusoside, steviol glycosides, or a rebaudioside such as rebaudioside A to F, M, N and X).

In embodiments of the invention, the composition further comprises a nutritive sweetener. For example, the nutritive sweetener may be one or more selected from the group consisting of a 3- to 12-carbon sugar alcohol, a monosaccharide and a sweet disaccharide. Particular nutritive sweeteners that may be mentioned in embodiments of the invention include one or more selected from the group consisting of allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose, or more particularly, glucose-fructose syrup, invert sugar, arabitol, glycerol, hydrogenated starch hydrolysate, isomalt, lactitol, maltitol, mannitol, sorbitol and xylitol; particularly allulose (also known as D-psicose), high fructose corn syrup, glucose and erythritol; and more particularly fructose and sucrose.

In further embodiments of the invention the ratio of the at least one high potency sweetener to the nutritive sweetener is from about 0.01 to about 6.25:1 on a weight to weight basis or from about 0.05:1 to about 6.25:1 on a weight to weight basis. For example, the ratio of the at least one high potency sweetener to the nutritive sweetener may be greater than about 0.1:1 and less than or equal to about 2:1, from about 0.15:1 to about 0.5:1 or, particularly, from about 0.17:1 to about 0.25:1 on a weight to weight basis. In particular embodiments of the invention, the ratio of the at least one high potency sweetener to the nutritive sweetener may be about 0.2:1 on a weight to weight basis.

In still further embodiments of the invention, the at least one anti-foaming agent comprises one or more selected from the group consisting of mineral oil, odourless light petroleum hydrocarbons, petrolatum, petroleum waxes, synthetic isoparaffinic petroleum hydrocarbons, synthetic petroleum wax, paraffin wax, microcrystalline wax, tallow, oxidized tallow, sulfated tallow, oleomargarine, lard, butter, oxystearin, a fatty acid metal salt, ethylene oxide polymer, copolymer condensates of ethylene oxide and propylene oxide, polyethylene glycol, polypropylene glycol, polyethylene glycol (400) dioleate, sorbitan monostearate, polysorbate 60 (polyoxyethylene (20) sorbitan monostearate), polysorbate 65 (polyoxyethylene (20) sorbitan tristearate), polysorbate (polyoxyethylene (20) sorbitan monooleate), n-butoxypolyoxyethylene polyoxypropylene glycol, polyoxyethylene (600) dioleate, polyoxyethylene (600) monoricinoleate and polyoxyethylene (40) monostearate; particularly lecithin, propylene glycol mono and diesters of fatty acids, propylene glycol alginate and calcium alginate; more particularly a fatty acid (e.g. selected from one or more of the group consisting of decanoic acid, oleic acid, capric acid, caprylic acid, lauric acid, myristic acid, palmitic acid and stearic acid) and an alkyl-substituted silicon dioxide; yet more particularly a fatty acid ester, a vegetable oil (e.g. selected from one or more of the group consisting of corn oil, coconut oil and cottonseed oil); and particularly a silicone oil and/or silicon dioxide. In particular embodiments of the invention, the at least one anti-foaming agent comprises polydimethylsiloxane and/or silicon dioxide. In an embodiment of the invention, the at least one anti-foaming agent comprises polydimethylsiloxane. In a further embodiment, the at least one anti-foaming agent comprises silicon dioxide. In yet a further embodiment, the at least one anti-foaming agent comprises polydimethylsiloxane and silicon dioxide.

In embodiments of the invention, the at least one anti-foaming agent has a hydrophilic-lipophilic balance value of less than or equal to 10.

In further embodiments of the invention, the ratio of the at least one high potency sweetener to the at least one anti-foaming agent is from about 2:1 to about 300:1 on a weight to weight basis. For example, the ratio of the at least one high potency sweetener to the at least one anti-foaming agent is from about 8:1 to about 250:1 or from about 20:1 to about 150:1 on a weight to weight basis. In particular embodiments of the invention, the ratio of the at least one high potency sweetener to the at least one anti-foaming agent may be from about 40:1 to about 100:1 on a weight to weight basis.

In yet further embodiments of the invention, the ratio of the at least one high potency sweetener to the at least one anti-foaming agent is from about 0.004:1 to about 300:1 on a weight to weight basis. For example, the ratio of the at least one high potency sweetener to the at least one anti-foaming agent is from about 0.004:1 to about 200:1, from about 0.004:1 to about 100:1, from about 0.008:1 to about 100:1, from about 0.01:1 to about 100:1, from about 0.1:1 to about 100:1 or from about 0.5:1 to about 100:1 on a weight to weight basis.

In embodiments of the invention, the sweetener composition may further comprise a flavour enhancer, wherein the flavour enhancer is a high potency sweetener that contains hydrophilic and hydrophobic structural moieties used in an amount below its sweetness threshold. In further embodiments, the flavour enhancer may be a high potency sweetener that is selected from one or more of the group consisting of a natural high potency sweetener, a synthetic high potency sweetener that is a glycoside, or a synthetic high potency sweetener that is derived from an amino acid, provided that the flavour enhancer is different to the at least one high potency sweetener. For example, when used in these embodiments, the high potency sweetener used as a flavour enhancer may be any of those defined hereinbefore.

In further embodiments of the invention, the sweetener composition can be formulated as a syrup, in powder form, in tablet form, as granules, or as a solution.

In yet further embodiments of the invention, the sweetener composition may comprise at least one high potency sweetener comprising a blend of Luo Han Guo extract and steviol glycosides (e.g. rubusoside or a rebaudioside, such as A to F, M, N and X)); at least one anti-foaming agent comprising polydimethylsiloxane and/or silicon dioxide; and a nutritive sweetener that is sucrose. For example, the at least one anti-foaming agent may be polydimethylsiloxane. Alternatively, the at least one anti-foaming agent may be silicon dioxide. For example, the at least one anti-foaming agent may be polydimethylsiloxane and silicon dioxide.

A second aspect of the invention provides a product for human and/or animal consumption, comprising a sweetener composition according to the first aspect of the invention.

In embodiments of the second aspect of the invention the product can be a food product, a beverage product, a pharmaceutical product, a nutritional product, a sports product, or a cosmetic product.

For example, when the product is a food product, the food product can be selected from the group consisting of a confectionary product, a dessert product, a cereal product, baked goods, frozen dairy products, meats, dairy products, condiments, snack bars, soups, dressings, mixes, prepared foods, baby foods, diet preparations, syrups, food coatings, dried fruit, sauces, gravies, and jams/jellies. For example, the food product may comprise the sweetener composition of the present invention as a coating or frosting formed on the surface of the product.

Alternatively, when the product is a beverage product, the beverage product can be selected from the group consisting of a concentrated beverage mix, a carbonated beverage, a non-carbonated beverage, fruit-flavoured beverage, fruit-juice, tea, milk, coffee, and the like.

In embodiments where the product is a beverage product, the beverage product may comprise a nutritive sweetener at a concentration of less than 5000 ppm and/or greater than or equal to 80 ppm.

In further embodiments, the beverage product has an acidic pH. For example the pH may be from about 2.0 to about 6.5.

In a further embodiment, the beverage product comprises at least one high potency sweetener selected from the group consisting of a Luo Han Guo extract and an ent-kaurane sweetener (e.g. a stevia extract, glucosylated steviol glycosides, rubusoside, steviol glycosides, or a rebaudioside, such as rebaudioside A to F, M, N and X), and salts and/or solvates thereof; and at least one anti-foaming agent selected from the group consisting of polydimethylsiloxane, fatty acid esters, silicon dioxide and vegetable oils. For example, the at least one high potency sweetener may comprise a Luo Han Guo extract and/or an ent-kaurane sweetener (e.g. a stevia extract, glucosylated steviol glycosides, rubusoside, steviol glycosides, or a rebaudioside, such as rebaudioside A to F, M, N and X); and the at least one anti-foaming agent may comprise polydimethylsiloxane (e.g. where the amount of polydimethylsiloxane is less than or equal to 10 ppm of the beverage). In further embodiments of the invention, the beverage product further comprises sucrose.

In a yet further embodiment of the second aspect of the invention, the sweetness onset time and/or sweet taste linger has been shortened relative to a product comprising the at least one high potency sweetener alone.

A third aspect of the invention provides a use of at least one anti-foaming agent to shorten the sweetness onset time and/or the sweet taste linger of at least one high potency sweetener, relative to said at least one high potency sweetener alone.

In embodiments of the third aspect of the invention, the at least one anti-foaming agent and the at least one high potency sweetener and the ratio therebetween are as defined in the previous aspects of the invention. For example, the at least one high potency sweetener contains hydrophilic and hydrophobic structural moieties. In further embodiments, the at least one high potency sweetener may be selected from the group consisting of a glycoside high potency sweetener, an amino acid-derived high potency sweetener and a protein-based high potency sweetener as defined in previous aspects of the invention.

A fourth aspect of the invention provides a method of making a sweetener composition according to the first aspect of the invention, said method comprising mixing at least one high potency sweetener with at least one anti-foaming agent.

In embodiments of this aspect, the method may further comprise mixing one or more nutritive sweeteners and/or one or more flavour enhancers together with the at least one high potency sweetener and the at least one anti-foaming agent, wherein said mixing occurs concomitantly with the mixing of the at least one high potency sweetener and the at least one anti-foaming agent, or sequentially following the mixing of the at least one high potency sweetener and the at least one anti-foaming agent, wherein the flavour enhancer is a high potency sweetener used in an amount below its sweetness threshold.

### BRIEF DESCRIPTION OF THE DRAWINGS

FIG. 1: is a graph showing the temporal profile (over 0 to 120 seconds) of Formula A (which is a Luo Han Guo extract) versus Formula A with 160 ppm and 4500 ppm fructose at neutral pH.

FIG. 2: is a graph showing the temporal profile (over 0 to 20 seconds) of Formula A versus Formula A with 160 ppm and 4500 ppm fructose at neutral pH.

FIG. 3: is a graph showing the temporal profile (over 0 to 120 seconds) of Formula A versus Formula A with 160 ppm and 4500 ppm fructose in acidic medium.

FIG. 4: is a graph showing the temporal profile (over 0 to 20 seconds) of Formula A versus Formula A with 160 ppm and 4500 ppm fructose in acidic medium.

FIG. 5: is a graph showing the temporal profile (over 0 to 120 seconds) of Formula A versus Formula A with 160 ppm and 4500 ppm fructose with anti-foamer at neutral pH.

FIG. 6: is a graph showing the temporal profile (over 0 to 20 seconds) of Formula A versus Formula A with 160 ppm and 4500 ppm fructose with anti-foamer at neutral pH.

FIG. 7: is a graph showing the temporal profile (over 0 to 120 seconds) of Formula A versus Formula A with 160 ppm and 4500 ppm fructose with anti-foamer in acidic medium.

FIG. 8: is a graph showing the temporal profile (over 0 to 20 seconds) of Formula A versus Formula A with 160 ppm and 4500 ppm fructose with anti-foamer in acidic medium.

FIG. 9: is a graph showing the temporal profile for sweetness (over 0 to 120 seconds) of soft drink sweetened with sugar versus soft drink sweetened with: Formula A; Formula A and anti-foamer; Formula A, anti-foamer and fructose.

FIG. 10: is a graph showing the temporal profile for sweetness (over 0 to 20 seconds) of soft drink sweetened with sugar versus soft drink sweetened with: Formula A; Formula A and anti-foamer; Formula A, anti-foamer and fructose.

FIG. 11: is a graph showing the temporal profile for flavour (over 0 to 120 seconds) of soft drink sweetened with sugar versus soft drink sweetened with: Formula A; Formula A and anti-foamer; Formula A, anti-foamer and fructose.

FIG. 12: is a graph showing the temporal profile for flavour (over 0 to 20 seconds) of soft drink sweetened with sugar versus soft drink sweetened with: Formula A; Formula A and anti-foamer; Formula A, anti-foamer and fructose.

FIG. 13: is a graph showing the temporal profile for sweetness (over 0 to 120 seconds) of Formula C (a blend of a Luo Han Guo extract and steviol glycosides) versus Formula C with: TEMP (sucrose and MD-20-S FG (a polydimethylsiloxane and silicon dioxide based antifoamer)); non-silicone anti-foamer; pure silicone oil; and natural anti-foamer.

FIG. 14: is a graph showing the temporal profile for sweetness (over 0 to 20 seconds) of Formula C versus Formula C with: TEMP (sucrose and MD-20-S FG); non-silicone anti-foamer; pure silicone oil; and natural anti-foamer.

### DETAILED DESCRIPTION

The present invention is based on the surprising finding that an anti-foaming agent can enhance the sweetness and/or flavour of a high potency sweetener that contains hydrophilic and hydrophobic structural moieties. That is to say, a composition or product containing an anti-foaming agent and the aforementioned high potency sweetener has an improved taste compared to the same composition or product without the inclusion of the anti-foaming agent. Examples of high potency sweeteners that contain hydrophilic and hydrophobic structural moieties are selected from the group consisting of a natural high potency sweetener, a synthetic high potency sweetener that is a glycoside, or a synthetic high potency sweetener that is derived from an amino acid.

Furthermore, it has been found that the inclusion of an anti-foaming agent in the aforementioned composition or product addresses problems that may be associated with the high potency sweeteners alone, in particular, with regard to metallic taste and/or undesirable temporal profile. Thus, the sweetener composition of the present invention and products containing it improve the balance of flavor by reducing off-taste, and provide a more desirable temporal profile.

In addition, the sweetener composition of the present invention and products containing it will generally be lower in calories compared to equivalent compositions and products sweetened with sucrose or fructose (e.g. high-fructose corn syrup).

The term “temporal profile” as used herein, is a measure of perceived sweetness intensity over time. A desirable or advantageous temporal profile is one wherein sweetness is observed quickly and has a short linger similar to that of sucrose.

Benefits that may be associated with embodiments of the present invention include better overall acceptability, better mouthfeel, reduced off-taste and a desirable temporal profile, as well as being cost effective.

In general terms, the present invention relates to a sweetener composition comprising:
at least one high potency sweetener; and
at least one anti-foaming agent, wherein
the at least one high potency sweetener contains hydrophilic and hydrophobic structural moieties.

The term “high potency sweetener contains hydrophilic and hydrophobic structural moieties” as used herein refers to a high potency sweetener that has an amphiphilic structure. Examples of high potency sweeteners that may be mentioned herein include those selected from the group consisting of a natural high potency sweetener, a synthetic high potency sweetener that is a glycoside, or a synthetic high potency sweetener that is derived from an amino acid.

The term “high potency sweetener” as used herein refers to a sweetener that has a sweetness by weight at least 10 times that of sucrose (sugar). For example, the sweetness by weight of a high potency sweetener in the currently claimed invention may be from 10 times to 10,000 times (e.g. 20 times to 9,000 times, such as 50 times to 8,000 times) that of sucrose. High potency sweeteners that may be mentioned in certain embodiments of the invention include abrusoside A, alitame, aspartame, baiyunoside, brazzein, curculin, cyclocarioside I, glycyphyllin, glycyrrhizic acid, a glucosylated steviol glycoside, hernandulcin, N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L[alpha]-aspartyl]-L-phenylalanine 1-methyl ester, a Luo Han Guo extract, mabinlin, N-[N-[3-(3-methoxy-4-hydroxyphenyl)propyl]-L-[alpha]-aspartyl]-L-phenylalanine 1-methyl ester, monatin, monellin, mukurozioside, neohesperidin dihydrochalcone, neotame, osladin, periandrins, phlomisosides, phloridzin, phyllodulcin, polypodoside A, pterocaryoside A, pterocaryoside B, an ent-kaurane sweetener (e.g. a stevia extract, glucosylated steviol glycosides, steviol glycosides, rubusoside, or a rebaudioside, such as rebaudioside A to F, M, N and X), thaumatin, trilobatin, and salts and/or solvates thereof.

The term “natural high potency sweetener” as used herein refers to a high potency sweetener obtained from a natural source. For example, a natural high potency sweetener may be used in its raw form (e.g. as a plant) or may be extracted or purified from the natural source. Natural high potency sweeteners that may be mentioned in certain embodiments of the invention include abrusoside A, baiyunoside, brazzein, curculin, cyclocarioside I, glycyphyllin, glycyrrhizic acid, hernandulcin, a Luo Han Guo extract, mabinlin, monatin, monellin, mukurozioside, osladin, periandrins, phlomisosides, phloridzin, phyllodulcin, polypodoside A, pterocaryoside A, pterocaryoside B, rubusoside, a stevia extract (e.g. e.g. steviol glycosides, or particularly a rebaudioside, such as rebaudioside A to F, M, N and X), thaumatin and trilobatin, and salts and/or solvates thereof.

The term “synthetic high potency sweetener” as used herein refers to a high potency sweetener that has been produced using one or more synthetic steps. Synthetic high potency sweeteners that may be mentioned in certain embodiments of the invention include alitame, aspartame, a glucosylated steviol glycoside, N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L[alpha]-aspartyl]-L-phenylalanine 1-methyl ester, N-[N-[3-(3-methoxy-4-hydroxyphenyl)propyl]-L[alpha]-aspartyl]-L-phenylalanine 1-methyl ester, neohesperidin dihydrochalcone, neotame, and salts and/or solvates thereof.

The term “high-potency sweetener that is a glycoside” or “glycoside-derived high potency sweeteners” as used herein refers to a high potency sweetener that is a molecule in which a sugar is bound to an organic moiety that is not itself a sugar. High-potency sweeteners that are glycosides that may be mentioned in certain embodiments of this invention include abrusoside A, baiyunoside, cyclocarioside I, dulcoside A, dulcoside B, glycyphyllin, glycyrrhizic acid, a glucosylated steviol glycoside, mogrosides (e.g. mogroside IV, mogroside V), mukurozioside, neomogroside, osladin, periandrins, phlomisosides, phloridzin, polypodoside A, pterocaryoside A, pterocaryoside B, a rebaudioside (e.g. rebaudioside A, rebaudioside B, rebaudioside C, rebaudioside D, rebaudioside E, rebaudioside F, rebaudioside M, rebaudioside N, rebaudioside X), rubusoside, siamenoside, stevia, stevioside, trilobatin and neohesperidin dihydrochalcone.

The term “high potency sweetener that is derived from an amino acid” or “amino acid-derived high potency sweetener” as used herein refers to a high potency sweetener that contains at least one amino acid as part of its molecular structure. High potency sweeteners that are derived from an amino acid and that may be mentioned in certain embodiments of this invention include monatin (e.g. monatin, monatin SS, monatin RR, monatin RS, monatin SR), N-[N-[3-(3-hydroxy-4-methoxyphenyl)propyl]-L[alpha]-aspartyl]-L-phenylalanine 1-methyl ester, N-[N-[3-(3-hydroxy-4-methoxyphenyl)-3-methylbutyl]-L[alpha]-aspartyl]-L-phenylalanine 1-methyl ester and N-[N-[3-(3-methoxy-4-hydroxyphenyl)propyl]-L[alpha]-aspartyl]-L-phenylalanine 1-methyl ester, and salts and/or solvates thereof.

The term “protein-based high potency sweetener” as used herein refers to a high potency sweetener that is a protein. Protein-based high potency sweeteners that may be mentioned in certain embodiments of this invention include brazzein, curculin, mabinlin, monellin and thaumatin.

The term “anti-foaming agent”, “defoaming agent” or variations of these terms as used herein refers to an agent that reduces and/or hinders the formation of a foam. That is, an anti-foaming agent may reduce a foam that has already formed or hinder the development of foam. Alternatively, the anti-foaming agent both reduces a foam that has already formed and hinders the formation of any further foam.

In an embodiment of the present invention, the at least one high potency sweetener of the sweetener composition is selected from the group consisting of abrusoside A, alitame, aspartame, baiyunoside, brazzein, curculin, cyclocarioside I, glycyphyllin, glycyrrhizic acid, a glucosylated steviol glycoside, hernandulcin, N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L[alpha]-aspartyl]-L-phenylalanine 1-methyl ester, a Luo Han Guo extract, mabinlin, N-[N-[3-(3-methoxy-4-hydroxyphenyl)propyl]-L-[alpha]-aspartyl]-L-phenylalanine 1-methyl ester, monatin, monellin, mukurozioside, neohesperidin dihydrochalcone, neotame, osladin, periandrins, phlomisosides, phloridzin, phyllodulcin, polypodoside A, pterocaryoside A, pterocaryoside B, an ent-kaurane sweetener (e.g. a stevia extract, glucosylated steviol glycosides, steviol glycosides, rubusoside, or a rebaudioside, such as rebaudioside A to F, M, N and X), thaumatin and trilobatin, and salts and/or solvates thereof.

In an embodiment, the at least one high potency sweetener is selected from the group consisting of abrusoside A, aspartame, baiyunoside, cyclocarioside I, glycyphyllin, glycyrrhizic acid, a glucosylated steviol glycoside, a Luo Han Guo extract, monatin, mukurozioside, neohesperidin dihydrochalcone, neotame, osladin, periandrins, phlomisosides, phloridzin, polypodoside A, pterocaryoside A, pterocaryoside B, an ent-kaurane sweetener (e.g. a stevia extract, glucosylated steviol glycosides, steviol glycosides, rubusoside, or a rebaudioside, such as rebaudioside A to F, M, N and X) and trilobatin, and salts and/or solvates thereof.

In a typical embodiment, the at least one high potency sweetener is selected from the group consisting of a Luo Han Guo extract, neohesperidin dihydrochalcone, neotame and an ent-kaurane sweetener (e.g. a stevia extract, glucosylated steviol glycosides, steviol glycosides, rubusoside, or a rebaudioside, such as rebaudioside A to F, M, N and X), and salts and/or solvates thereof.

In a typical embodiment, the at least one high potency sweetener comprises a Luo Han Guo extract. In a further embodiment, the high potency sweetener is an ent-kaurane sweetener (e.g. a stevia extract, glucosylated steviol glycosides, steviol glycosides, rubusoside, or a rebaudioside, such as rebaudioside A to F, M, N and X). In yet a further embodiment, the high potency sweetener is a Luo Han Guo extract and an ent-kaurane sweetener (e.g. a stevia extract, glucosylated steviol glycosides, steviol glycosides, rubusoside, or a rebaudioside, such as rebaudioside A to F, M, N and X).

The term “Monk Fruit extract” or “Luo Han Guo extract” as used herein refers to an extract or sample taken from a Monk Fruit from the Monk Fruit plant (i.e. a Luo Han Guo fruit from a Luo Han Guo plant), Siraitia grosvenorii, comprising at least one mogroside. The term “mogroside composition” as used herein refers to a composition comprising at least one mogroside.

The term “mogroside” as used herein refers to a family of compounds found in plants such as Monk Fruit, also known as Luo Han Guo. Mogrosides are glycosides of cucurbitane derivatives.

Mogroside V (also known as esgoside) has the following formula:

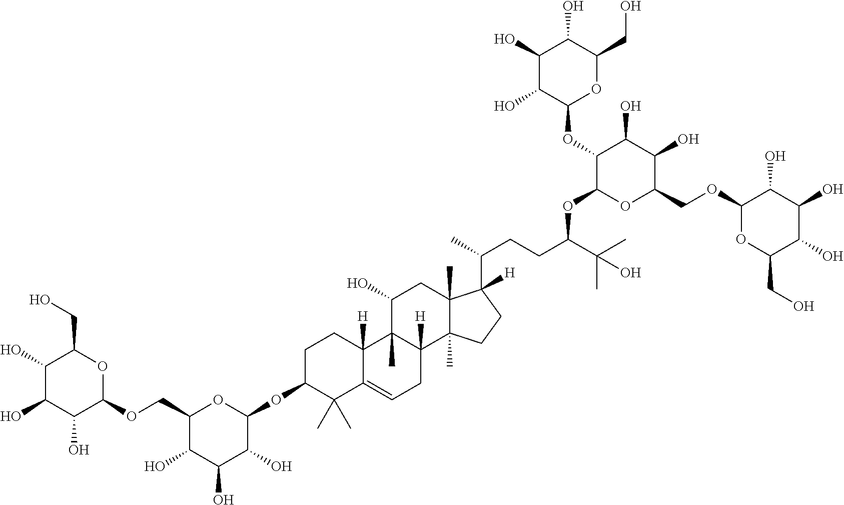

Mogroside IV has the following formula:

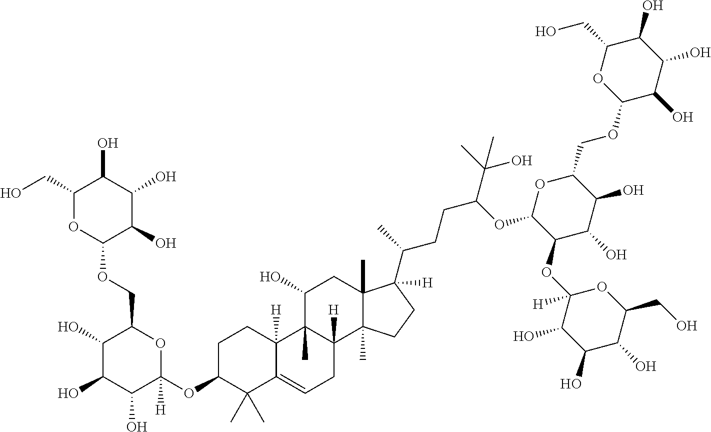

11-Oxomogroside V has the following formula:

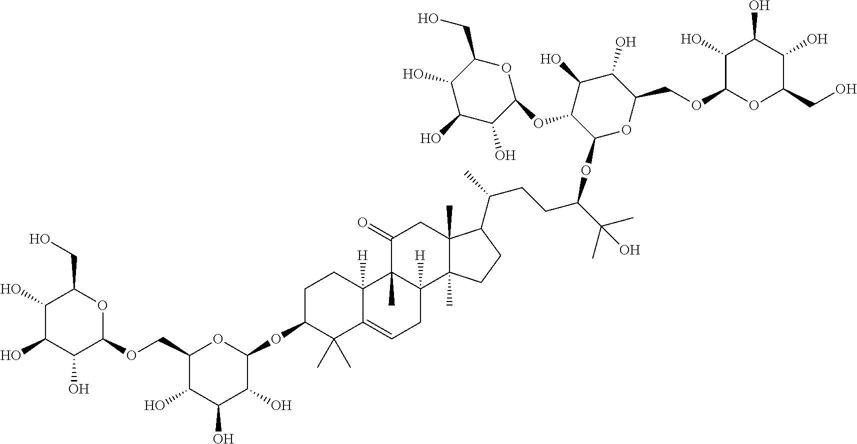

Siamenoside I has the following formula:

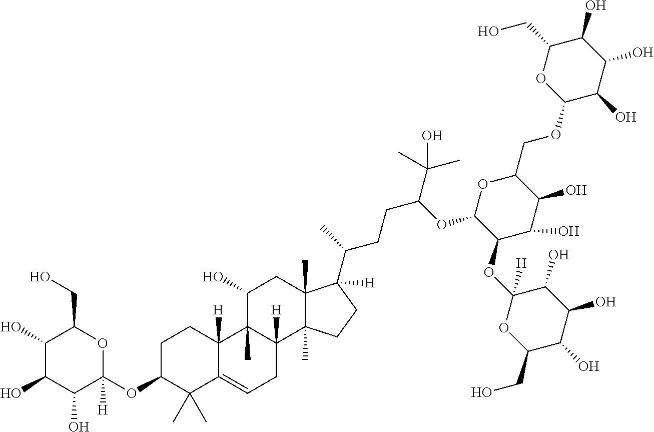

Mogroside VI has the following formula:

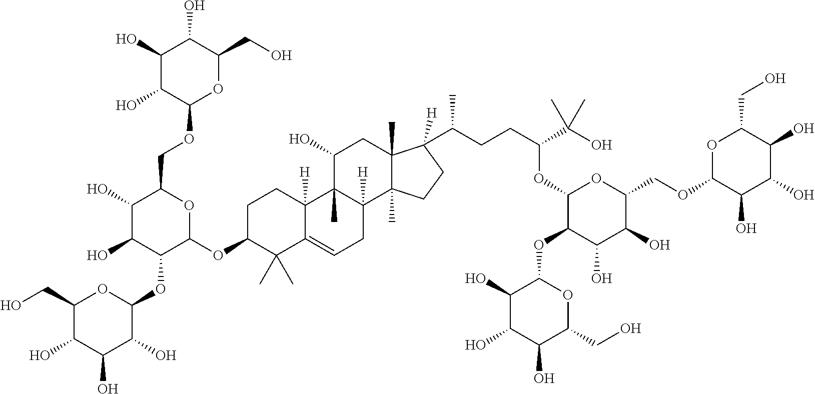

Mogroside III E has the following formula:

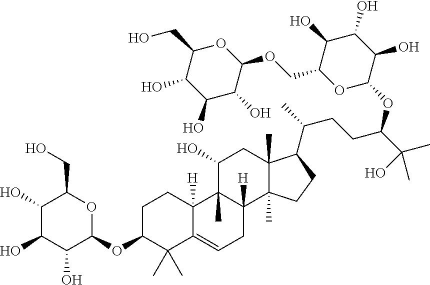

Further mogrosides include neomogroside.

In an embodiment, the mogroside is selected from the group consisting of mogroside V, mogroside IV, mogroside VI, oxomogroside V (e.g. 11-oxomogroside V), mogroside 111E, neomogroside and siamenoside I or mixtures thereof. It is generally preferred that at least four mogrosides are present in the sweetener composition namely, mogroside V, mogroside IV, 11-oxomogroside V and siamenoside I. It is particularly preferred that the at least one mogroside is mogroside V.

In a further preferred embodiment, the at least one mogroside is from a fruit from a plant of the Cucurbitaceae family. The Cucurbitaceae family of plants includes the plant species Siraitia grosvenorrii, which is also known as the Monk Fruit plant. The mogroside may be present in the sweetener composition of the present invention in an extract from a fruit of a plant of the Cucurbitaceae family. The fruit extract comprises at least one mogroside. It is particularly preferred that the fruit is the Monk Fruit from the species Siraitia grosvenorrii.

The fruit extract or Monk Fruit extract for use in the present invention may be prepared as follows: The fruit is crushed to release its natural juices. The crushed fruit is then infused with hot water to extract the vitamins, antioxidants and sweet components. The infusion is then passed through a series of filters to obtain a pure, sweet fruit concentrate.

In a particularly preferred embodiment, the fruit extract comprises a mogroside composition in an amount of at least about 50% by weight relative to the total weight of the fruit extract. Preferably, the fruit extract comprises a mogroside composition in an amount of about 50% to about 90% by weight relative to the total weight of the fruit extract.

Luo Han Guo extracts are available commercially from a number of sources. Methods of producing such extracts are described in U.S. Pat. No. 5,411,755 and U.S. Publication No. 2006/0003053, the entire content of which is incorporated herein by reference. Typically, mogroside V is the most abundant single mogroside component of Luo Han Guo extracts, accompanied by other mogrosides such as mogrosides I, II, III, IV and VI as well as other extracted materials, such as polyphenols, flavonoids, melanoidins, terpenes, proteins, sugars, aromatic glycosides, and semi-volatile organic compounds. In some embodiments of the invention, the mogroside V is provided in the form of a Luo Han Guo extract (either raw or purified and/or concentrated to increase mogroside V content).

In a preferred embodiment, the mogroside composition comprises at least one mogroside selected from the group consisting of mogroside V, mogroside IV, mogroside VI, oxomogroside V (e.g. 11-oxomogroside V), mogroside IIIE and siamenoside I or mixtures thereof. It is generally preferred that at least four mogrosides are present in the mogroside composition, namely, mogroside V, mogroside IV, 11-oxomogroside V and siamenoside I.

It is particularly preferred that the fruit extract comprises about 40% to about 65% by weight of mogroside V and about 0% to about 30% by weight of mogroside IV, mogroside VI, oxomogroside V (e.g. 11-oxomogroside V), mogroside IIIE or siamenoside I, or mixtures thereof.

In a further embodiment, the fruit extract comprises about 50% to about 60% by weight of mogroside V and about 0% to about 30% by weight of mogroside IV, mogroside VI, oxomogroside V (e.g. 11-oxomogroside V), mogroside IIIE or siamenoside I, or mixtures thereof.

In a further preferred embodiment, the fruit extract comprises about 40%, 41%, 42%, 43%, 44%, 45%, 46%, 47%, 48%, 49%, 50%, 51%, 52%, 53%, 54%, 55%, 56%, 57%, 58%, 59%, or 60% by weight of mogroside V. Furthermore, the fruit extract preferably comprises about 0%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% by weight of mogroside IV, mogroside VI, oxomogroside V (e.g. 11-oxomogroside V), mogroside IIIE or siamenoside I, or mixtures thereof.

In alternative embodiments, mogroside V constitutes at least 40 wt % of the extract, or at least 45 wt %, or at least 50 wt %. Typically, mogroside V will constitute at most 95 wt % of the extract, at most 85 wt % of the extract, at most 75 wt % of the extract, at most 70 wt % of the extract, or at most 65 wt %, or at most 60 wt %.

For example, the Luo Han Guo extract may be one of the Luo Han Guo extracts described in U.S. 2012/0264831, the entire content of which is incorporated herein by reference. In particular, the Luo Han Guo extract and blend disclosed in Examples 1 and 5, respectively, of U.S. 2012/0264831 are incorporated herein by reference.

Commercially available Luo Han Guo powdered fruit extract (e.g. as obtained following the methods of producing such extracts described in U.S. Pat. No. 5,411,755 and U.S. Publication. No. 2006/0003053), typically containing at least 40% of Mogroside V (d.s.b), may be treated with activated carbon as follows. Dry extract is dissolved in deionized water at a concentration of at least about 1 wt %, and typically at most about 70 wt %. The water is heated to a temperature sufficient to favour the dissolution of the powdered material, typically in a range between ambient temperature and 71.1° C., and optionally filtered using a microfiltration membrane or using filtration paper with a non-reactive filtration aid. The purpose of the microfiltration is to remove insoluble proteins and/or microorganisms that could deteriorate the product. The resulting filtrate is subjected to adsorption with active carbon (also known as activated carbon). The carbon may be any form of active carbon available, and may for example be derived from wood, bituminous coal, lignite coal, coconut, bone char, or any other source. In one embodiment, the active carbon is obtained by steam activation of carbon from lignite coal. Typically, the carbon is in the form of granules, but other physical forms such as powders or bead activated carbon may also be employed. It will generally be advantageous to utilize an active carbon which is highly porous and which has a high surface area (e.g., over 100 m²/g, over 200 m²/g, or over 300 m²/g). The non-desirable components causing the off-taste (as well as other undesirable substances such as pesticides) are adsorbed to the carbon, but the improved taste material is not adsorbed and is continuously eluted. The method allows for recovery yields (dry substance basis) between 50% and 99.9%. The amount of active carbon used may vary from 0.05% to 150% (as a percentage of the dry substance present in the aqueous solution of Luo Han Guo fruit extract). More typically, to achieve sufficiently low levels of off-taste components, at least 2 wt % or at least 5 wt % of activated carbon relative to Luo Han Guo fruit extract is used on a solids basis. Preferably, at least 6 wt % or at least 10 wt % of activated carbon relative to Luo Han Guo fruit extract gives the best results. Typically, at most 15 wt % will be used.

The term “an ent-kaurane sweetener” as used herein refers to any high potency sweetener that contains a core structure that is derived from ent-kaurane. In an embodiment, the ent-kaurane sweetener may be a stevia extract, one or more glucosylated steviol glycosides, or one or more steviol glycosides. In further embodiments, the ent-kaurane sweetener may be rubusoside, or a rebaudioside (e.g. rebaudioside A to F, M, N and X).

The term “stevia extract” as used herein refers to an extract or sample taken from a Stevia plant, Stevia rebaudiana, comprising at least one steviol glycoside. The term “steviol glycoside” means any of a number of naturally occurring compounds with a general structure of the steviol diterpene ring system with one or more saccharide residues chemically attached to the ring. In the present specification, the terms “stevia extract” and “steviol glycosides” may be used interchangeably.

Steviol glycosides that may be extracted from Stevia include the six rebaudiosides (i.e., rebaudioside A to F, M, N and X), rubusoside, stevioside (the predominant glycoside in extracts from wild type Stevia), and dulcosides. Any of said steviol glycosides may be used in embodiments of the invention.

The stevia extract that may be used in the present invention preferably comprises steviol glycosides in a total amount of at least 90 weight %, preferably in a total amount of 95 weight % or more, relative to the total weight of the stevia extract on a dry solids basis. For example, the stevia extract may comprise steviol glycosides in a total amount of at least 90, 91, 92, 93, 94, 95, 96, 97, 98 or 99 weight %, relative to the total weight of the stevia extract on a dry solids basis.

In particular embodiments of the invention, when a stevia extract is used, the extract preferably contains rebaudioside A and rebaudioside B. For example, the stevia extract may comprise Rebaudioside A in an amount of from about 60 weight % to about 85 weight %, preferably from about 70 weight % to about 85 weight %, and more preferably from about 75 weight % to about 80 weight %, relative to the combined total weight of steviol glycosides in the stevia extract on a dry solids basis. In some embodiments, the stevia extract comprises Rebaudioside A in an amount of from about 60 weight % to about 80 weight %, preferably from about 67 weight % to about 73 weight %, relative to the combined total weight of steviol glycosides in the stevia extract on a dry solids basis. For example, the stevia extract may comprise Rebaudioside A in an amount of 60, 61, 62, 63, 64, 65, 66, 67, 68, 69, 70, 71, 72, 73, 74, 75, 76, 77, 78, 79, 80, 81, 82, 83, 84 or 85 weight %, relative to the combined total weight of steviol glycosides in the stevia extract on a dry solids basis.

In preferred embodiments, the stevia extract comprises Rebaudioside B in an amount of from about 15 weight % to about 30 weight %, preferably from about 19 weight % to about 23 weight %, relative to the combined total weight of steviol glycosides in the stevia extract on a dry solids basis. For example, the stevia extract may comprise Rebaudioside B in an amount of 15, 16, 17, 18, 19, 20, 21, 22, 23, 24, 25, 26, 27, 28, 29 or 30 weight %, relative to the combined total weight of steviol glycosides in the stevia extract on a dry solids basis.

In further preferred embodiments, the stevia extract comprises Rebaudioside A and Stevioside in a combined total amount of at least 70 weight %, preferably in a combined total amount of 75 weight % or more, relative to the total weight of the stevia extract on a dry solids basis.

Alternatively, the stevia extract may be the stevia extracts described in WO 2012/102769, the entire content of which is incorporated herein by reference. A particular stevia extract that may be mentioned herein relates to the stevia extract described as an embodiment of the invention in Example 1 of WO 2012/102769, and is incorporated herein by reference.

For example, a stevia extract that may be mentioned herein may relate to a formulation containing 70.56 wt % rebaudioside A, 6.45 wt % stevioside, 20.97 wt % rebaudioside B and 2.02 wt % rebaudioside C. Alternatively or additionally, a stevia extract that may be mentioned herein may relate to a formulation having a concentration of rebaudioside B relative to the total amount of sweet steviol glycosides of about 21% and a ratio of rebaudioside A to rebaudioside B of about 3:1.

It will be appreciated that combinations or blends of various high potency sweeteners may be used. For example, a blend that may be used in embodiments of the invention relates to a blend comprising 75 wt % of a purified Luo Han Guo extract prepared according to the method outlined above with 25 wt % of a stevia extract consisting of approximately 75 wt % rebaudioside A and 25 wt % stevioside.

The term “glucosylated steviol glycoside” as used herein refers to a-glucosylated steviol glycosides such that additional glucose moieties (generally one to three additional glucose moieties) are bonded to the original steviol glycoside structure via sterio- and regio-specific 1,4-α-D-glycosidic bonds. Non-limiting examples of a glucosylated steviol glycoside include monoglucosyl rebaudioside B, monoglucosyl stevioside, monoglucosyl rebaudioside C, monoglucosyl rebaudioside A, diglucosyl rebaudioside B, diglucosylstevioside, diglucosyl rebaudioside C, diglucosyl rebaudioside A, triglucosyl rebaudioside B and triglucosyl rebaudioside A.

The term “salts thereof” when used herein refers to acid addition salts and base addition salts. Such salts may be formed by conventional means, for example by reaction of a free acid or a free base form of a sweetener with one or more equivalents of an appropriate acid or base, optionally in a solvent, or in a medium in which the salt is insoluble, followed by removal of said solvent, or said medium, using standard techniques (e.g. in vacuo, by freeze-drying or by filtration). Salts may also be prepared by exchanging a counter-ion of a sweetener in the form of a salt with another counter-ion, for example using a suitable ion exchange resin.

Examples of salts that may be mentioned herein include acid addition salts derived from mineral acids and organic acids, and salts derived from metals such as calcium, magnesium, or preferably, potassium and sodium.

Particular examples of salts are salts derived from mineral acids such as hydrochloric, hydrobromic, phosphoric, metaphosphoric, nitric and sulphuric acids; from organic acids, such as tartaric, acetic, citric, malic, lactic, fumaric, benzoic, glycolic, gluconic, succinic, arylsulphonic acids; and from metals such as sodium, magnesium, or preferably, potassium and calcium.

The term “solvates” when used herein refers to the sweeteners and their salts. Solvates that may be mentioned herein are solvates formed by the incorporation into the solid state structure (e.g. crystal structure) of the sweeteners of a non-toxic solvent (referred to below as the solvating solvent). Examples of such solvents include water, alcohols (such as ethanol, isopropanol and butanol) and dimethylsulphoxide. Solvates can be prepared by recrystallising the sweeteners with a solvent or mixture of solvents containing the solvating solvent. Whether or not a solvate has been formed in any given instance can be determined by subjecting crystals of the sweetener to analysis using well known and standard techniques such as thermogravimetric analysis (TGE), differential scanning calorimetry (DSC) and X-ray crystallography.

The solvates can be stoichiometric or non-stoichiometric solvates. Particular solvates that may be mentioned herein are hydrates, and examples of hydrates include hemihydrates, monohydrates and dihydrates.

In further embodiments, the sweetener composition further comprises a nutritive sweetener.

The term “nutritive sweetener” as used herein refers to a sweetener that contains carbohydrate and provides energy. Nutritive sweeteners may be further classified into monosaccharides or disaccharides, which impart 4 kcal/g, or sugar alcohols (polyols), which provide an average of 2 kcal/g, as discussed in “Position of the American Dietetic Association: Use of nutritive and nonnutritive sweeteners” J. Am. Diet Assoc. 2004; 104(2):255-275.

In an embodiment, the nutritive sweetener is one or more selected from the group consisting of a 3- to 12-carbon sugar alcohol, a monosaccharide and a sweet disaccharide. For example, the nutritive sweetener may be one or more selected from the group consisting of allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose, or particularly, sucrose, fructose, glucose, glucose-fructose syrup, high fructose corn syrup, invert sugar, allulose (also known as D-psicose), arabitol, erythritol, glycerol, hydrogenated starch hydrolysate, isomalt, lactitol, maltitol, mannitol, sorbitol and xylitol.

In an alternative embodiment, the nutritive sweetener is one or more selected from the group consisting of sucrose, fructose, allulose (D-psicose), high fructose corn syrup, glucose and erythritol.

In a preferred embodiment, the nutritive sweetener is fructose and/or sucrose.

In embodiments, the ratio of the at least one high potency sweetener to the nutritive sweetener in the sweetener composition is from about 0.01:1 to about 6.25:1 or from about 0.05:1 to about 6.25:1 on a weight to weight basis. For example, the ratio of the at least one high potency sweetener to the nutritive sweetener is greater than about 0.1:1 and less than or equal to about 2:1 or is from about 0.15:1 to about 0.5:1 on a weight to weight basis.

In alternative embodiments, the ratio of the at least one high potency sweetener to the nutritive sweetener is from about 0.17:1 to about 0.25:1 on a weight to weight basis.

In preferred embodiments, the ratio of the at least one high potency sweetener to the nutritive sweetener is about 0.2:1 on a weight to weight basis.

In embodiments, the at least one anti-foaming agent of the sweetener composition comprises one or more selected from the group consisting of a fatty acid, a fatty acid ester, a silicone oil, silicon dioxide, an alkyl-substituted silicon dioxide, lecithin, a vegetable oil, propylene glycol mono and diesters of fatty acids, propylene glycol alginate, calcium alginate, mineral oil, odourless light petroleum hydrocarbons, petrolatum, petroleum waxes, synthetic isoparaffinic petroleum hydrocarbons, synthetic petroleum wax, paraffin wax, microcrystalline wax, tallow, oxidized tallow, sulfated tallow, oleomargarine, lard, butter, oxystearin, a fatty acid metal salt, ethylene oxide polymer, copolymer condensates of ethylene oxide and propylene oxide, polyethylene glycol, polypropylene glycol, polyethylene glycol (400) dioleate, sorbitan monostearate, polysorbate 60 (polyoxyethylene (20) sorbitan monostearate), polysorbate 65 (polyoxyethylene (20) sorbitan tristearate), polysorbate 80 (polyoxyethylene (20) sorbitan monooleate), n-butoxypolyoxyethylene polyoxypropylene glycol, polyoxyethylene (600) dioleate, polyoxyethylene (600) monoricinoleate and polyoxyethylene (40) monostearate. For example, anti-foaming agents that may be mentioned herein include a fatty acid, a fatty acid ester, a silicone oil, silicon dioxide, an alkyl-substituted silicon dioxide, lecithin, a vegetable oil, propylene glycol mono and diesters of fatty acids, propylene glycol alginate and calcium alginate.

In alternative embodiments, the at least one anti-foaming agent comprises one or more selected from the group consisting of decanoic acid, oleic acid, capric acid, caprylic acid, lauric acid, myristic acid, palmitic acid, stearic acid, a fatty acid ester, a silicone oil, silicon dioxide, an alkyl-substituted silicon dioxide, corn oil, coconut oil and cottonseed oil.

The term “alkyl-substituted silicon dioxide” as used herein refers to a solid silicon dioxide polymer where one or two oxygen atoms attached to one or more silicon atoms have been replaced by an alkyl group (e.g. a methyl or ethyl group).

The term “silicone oil” refers to any liquid polymerised siloxane with organic side chains. They are formed with a backbone of alternating silicon-oxygen atoms ( . . . Si—O—Si—O—Si . . . ) where the organic side chains are attached to the silicon atoms. Examples of silicone oils include polydimethylsiloxane and hexamethyldisiloxane.

In preferred embodiments, the at least one anti-foaming agent comprises one or more selected from the group consisting of polydimethylsiloxane, a fatty acid ester, silicon dioxide, corn oil, coconut oil and cottonseed oil.

The term “a fatty acid ester” as used herein refers to an alkyl ester of decanoic acid, oleic acid, capric acid, caprylic acid, lauric acid, myristic acid, palmitic acid, stearic acid (e.g. methyl, ethyl, propyl or butyl esters of said fatty acids). Preferably, the fatty acid ester comprises butyl stearate.

In preferred embodiments, the at least one anti-foaming agent comprises polydimethylsiloxane or a combination of polydimethylsiloxane and silicon dioxide.

In embodiments, the at least one anti-foaming agent has a hydrophilic-lipophilic balance value of less than or equal to 10.

The term “hydrophilic-lipophilic balance” as used herein relates to the measurement of the degree to which a compound is hydrophilic or lipophilic, determined by calculating values for the different regions of the molecule, as described by Griffin (Griffin, W. C. (1949), Journal of the Society of Cosmetic Chemists 1 (5): 311-26 and Griffin, William C. (1954), Journal of the Society of Cosmetic Chemists 5 (4): 249-56). This method requires the use of Formula (i) below:

Hydrophilic-lipophilic balance=20×Mh/M (i),

where Mh is the molecular mass of the hydrophilic portion of the molecule, and M is the molecular mass of the whole molecule, giving a result on a scale of 0 to 20. A hydrophilic-lipophilic balance value of 0 corresponds to a completely lipophilic/hydrophobic molecule, and a value of 20 corresponds to a completely hydrophilic/lipophobic molecule. In general, a value of 10 or below corresponds to a lipid soluble (water insoluble) molecule.

In further embodiments, the ratio of the at least one high potency sweetener to the at least one anti-foaming agent in the sweetener composition is from about 2:1 to about 300:1 on a weight to weight basis. For example, the ratio of the at least one high potency sweetener to the at least one anti-foaming agent is from about 8:1 to about 250:1 on a weight to weight basis.

Alternatively, the ratio of the at least one high potency sweetener to the at least one anti-foaming agent is from about 20:1 to about 150:1 on a weight to weight basis.

In preferred embodiments, the ratio of the at least one high potency sweetener to the at least one anti-foaming agent is from about 40:1 to about 100:1 on a weight to weight basis.

In yet further embodiments, the ratio of the at least one high potency sweetener to the at least one anti-foaming agent is from about 0.004:1 to about 300:1 on a weight to weight basis. For example, the ratio of the at least one high potency sweetener to the at least one anti-foaming agent is from about 0.004:1 to about 200:1 on a weight to weight basis.

Alternatively, the ratio of the at least one high potency sweetener to the at least one anti-foaming agent is from about 0.004:1 to about 150:1 on a weight to weight basis.

Alternatively, the ratio of the at least one high potency sweetener to the at least one anti-foaming agent is from about 0.004:1 to about 100:1 on a weight to weight basis.

Alternatively, the ratio of the at least one high potency sweetener to the at least one anti-foaming agent is from about 0.008:1 to about 100:1 on a weight to weight basis.

Alternatively, the ratio of the at least one high potency sweetener to the at least one anti-foaming agent is from about 0.01:1 to about 100:1 on a weight to weight basis.

Alternatively, the ratio of the at least one high potency sweetener to the at least one anti-foaming agent is from about 0.1:1 to about 100:1 on a weight to weight basis.

Alternatively, the ratio of the at least one high potency sweetener to the at least one anti-foaming agent is from about 0.5:1 to about 100:1 on a weight to weight basis.

In further embodiments, the ratio of the at least one high potency sweetener to the at least one anti-foaming agent in the sweetener composition is from about 2:1 to about 300:1 on a weight to weight basis (preferably from about 8:1 to about 250:1, more preferably from about 20:1 to about 150:1, or more preferably from about 40:1 to about 100:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.1:1 to about 2:1, more preferably from about 0.15:1 to about 0.5:1, more preferably from about 0.17:1 to about 0.25:1, or more preferably about 0.2:1 on a weight to weight basis).

In further embodiments, the ratio of the at least one high potency sweetener to the at least one anti-foaming agent in the sweetener composition is from about 0.004:1 to about 300:1 on a weight to weight basis (preferably from about 0.004:1 to about 200:1, more preferably from about 0.004:1 to about 150:1, or more preferably from about 0.004:1 to about 100:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.1:1 to about 2:1, more preferably from about 0.15:1 to about 0.5:1, more preferably from about 0.17:1 to about 0.25:1, or more preferably about 0.2:1 on a weight to weight basis).

In further embodiments, the ratio of the at least one high potency sweetener to the at least one anti-foaming agent in the sweetener composition is from about 2:1 to about 300:1 on a weight to weight basis (preferably from about 2:1 to about 200:1, more preferably from about 2:1 to about 150:1, more preferably from about 2:1 to about 100:1, even more preferably from about 2:1 to about 50:1 and even more preferably from about 2:1 to about 40:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.02:1 to about 3:1, more preferably from about 0.02:1 to about 2.75:1, more preferably from about 0.02:1 to about 2.5:1, more preferably from about 0.02:1 to about 1.5:1, even more preferably from about 0.02:1 to about 0.5:1, or even more preferably from about 0.03:1 to about 0.2:1 on a weight to weight basis).

In yet further embodiments, when the at least one high potency sweetener is selected from the group consisting of a Luo Han Guo extract, neohesperidin dihydrochalcone, neotame, a glucosylated steviol glycoside, rubusoside, a steviol glycoside and a stevia extract, and salts and/or solvates thereof; the at least one anti-foaming agent is selected from the group consisting of a fatty acid, (e.g. selected from one or more of the group consisting of decanoic acid, oleic acid, capric acid, caprylic acid, lauric acid, myristic acid, palmitic acid and stearic acid) a fatty acid ester, a silicone oil, silicon dioxide, an alkyl-substituted silicon dioxide (e.g. polydimethylsiloxane), lecithin, a vegetable oil, propylene glycol mono and diesters of fatty acids, propylene glycol alginate and calcium alginate; and the nutritive sweetener is selected from the group consisting of sucrose, fructose, allulose, high fructose corn syrup, glucose and erythritol the ratio of the at least one high potency sweetener to the at least one anti-foaming agent in the sweetener composition is from about 0.004:1 to about 300:1 on a weight to weight basis (preferably from about 0.004:1 to about 200:1, more preferably from about 0.004:1 to about 150:1, or more preferably from about 0.004:1 to about 100:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.1:1 to about 2:1, more preferably from about 0.15:1 to about 0.5:1, more preferably from about 0.17:1 to about 0.25:1, or more preferably about 0.2:1 on a weight to weight basis).

In yet further embodiments, when the at least one high potency sweetener is selected from the group consisting of a Luo Han Guo extract, neohesperidin dihydrochalcone, neotame, a glucosylated steviol glycoside, rubusoside, a steviol glycoside and a stevia extract, and salts and/or solvates thereof; the at least one anti-foaming agent is selected from the group consisting of a fatty acid, (e.g. selected from one or more of the group consisting of decanoic acid, oleic acid, capric acid, caprylic acid, lauric acid, myristic acid, palmitic acid and stearic acid) a fatty acid ester, a silicone oil, silicon dioxide, an alkyl-substituted silicon dioxide (e.g. polydimethylsiloxane), lecithin, a vegetable oil, propylene glycol mono and diesters of fatty acids, propylene glycol alginate and calcium alginate; and the nutritive sweetener is selected from the group consisting of sucrose, fructose, allulose, high fructose corn syrup, glucose and erythritol the ratio of the at least one high potency sweetener to the at least one anti-foaming agent in the sweetener composition is from about 2:1 to about 300:1 on a weight to weight basis (preferably from about 8:1 to about 250:1, more preferably from about 20:1 to about 150:1, or more preferably from about 40:1 to about 100:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.1:1 to about 2:1, more preferably from about 0.15:1 to about 0.5:1, more preferably from about 0.17:1 to about 0.25:1, or more preferably about 0.2:1 on a weight to weight basis).

In yet further embodiments, when the at least one high potency sweetener is selected from the group consisting of a Luo Han Guo extract, neohesperidin dihydrochalcone, neotame, a glucosylated steviol glycoside, rubusoside, a steviol glycoside and a stevia extract, and salts and/or solvates thereof; the at least one anti-foaming agent is selected from the group consisting of a fatty acid, (e.g. selected from one or more of the group consisting of decanoic acid, oleic acid, capric acid, caprylic acid, lauric acid, myristic acid, palmitic acid and stearic acid) a fatty acid ester, a silicone oil, silicon dioxide, an alkyl-substituted silicon dioxide (e.g. polydimethylsiloxane), lecithin, a vegetable oil, propylene glycol mono and diesters of fatty acids, propylene glycol alginate and calcium alginate; and the nutritive sweetener is selected from the group consisting of sucrose, fructose, allulose, high fructose corn syrup, glucose and erythritol the ratio of the at least one high potency sweetener to the at least one anti-foaming agent in the sweetener composition is from about 2:1 to about 300:1 on a weight to weight basis (preferably from about 2:1 to about 200:1, more preferably from about 2:1 to about 150:1, more preferably from about 2:1 to about 100:1, even more preferably from about 2:1 to about 50:1 and even more preferably from about 2:1 to about 40:1 on a weight to weight basis) and the ratio of the at least one high potency sweetener to the nutritive sweetener in the sweetener composition is from about from about 0.02:1 to about 6.25:1 on a weight to weight basis (preferably from about 0.02:1 to about 3:1, more preferably from about 0.02:1 to about 2.75:1, more preferably from about 0.02:1 to about 2.5:1, more preferably from about 0.02:1 to about 1.5:1, even more preferably from about 0.02:1 to about 0.5:1, or even more preferably from about 0.03:1 to about 0.2:1 on a weight to weight basis).

In yet further embodiments, when the at least one high potency sweetener is selected from the group consisting of a Luo Han Guo extract and/or a stevia extract, and salts and/or solvates thereof; the at least one anti-foaming agent is selected from the group consisting of polydimethylsiloxane, a fatty acid ester, silicon dioxide, corn oil, coconut oil and cottonseed oil; and the nutritive sweetener is selected from the group consisting of sucrose, fructose, allulose, high fructose corn syrup, glucose and erythritol the ratio of the at least one high potency sweetener to the at least one anti-foaming agent in the sweetener composition is from about 2:1 to about 300:1 on a weight to weight basis (preferably from about 8:1 to about 250:1, more preferably from about 20:1 to about 150:1, or more preferably from about 40:1 to about 100:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.1:1 to about 2:1, more preferably from about 0.15:1 to about 0.5:1, more preferably from about 0.17:1 to about 0.25:1, or more preferably about 0.2:1 on a weight to weight basis).

In yet further embodiments, when the at least one high potency sweetener is selected from the group consisting of a Luo Han Guo extract and/or a stevia extract, and salts and/or solvates thereof; the at least one anti-foaming agent is selected from the group consisting of polydimethylsiloxane, a fatty acid ester, silicon dioxide, corn oil, coconut oil and cottonseed oil; and the nutritive sweetener is selected from the group consisting of sucrose, fructose, allulose, high fructose corn syrup, glucose and erythritol the ratio of the at least one high potency sweetener to the at least one anti-foaming agent in the sweetener composition is from about 2:1 to about 300:1 on a weight to weight basis (preferably from about 2:1 to about 200:1, more preferably from about 2:1 to about 150:1, more preferably from about 2:1 to about 100:1, even more preferably from about 2:1 to about 50:1 and even more preferably from about 2:1 to about 40:1 on a weight to weight basis) and the ratio of the at least one high potency sweetener to the nutritive sweetener in the sweetener composition is from about from about 0.02:1 to about 6.25:1 on a weight to weight basis (preferably from about 0.02:1 to about 3:1, more preferably from about 0.02:1 to about 2.75:1, more preferably from about 0.02:1 to about 2.5:1, more preferably from about 0.02:1 to about 1.5:1, even more preferably from about 0.02:1 to about 0.5:1, or even more preferably from about 0.03:1 to about 0.2:1 on a weight to weight basis).

In yet further embodiments, when the at least one high potency sweetener is selected from the group consisting of a Luo Han Guo extract and/or a stevia extract; the at least one anti-foaming agent comprises polydimethylsiloxane and/or silicon dioxide; and the nutritive sweetener is fructose and/or sucrose, the ratio of the at least one high potency sweetener to the at least one anti-foaming agent in the sweetener composition is from about 2:1 to about 300:1 on a weight to weight basis (preferably from about 8:1 to about 250:1, more preferably from about 20:1 to about 150:1, or more preferably from about 40:1 to about 100:1 on a weight to weight basis) and the ratio of the at least one high potency sweetener to the nutritive sweetener in the sweetener composition is from about 0.01:1 to about 6.25:1 or from about 0.05:1 to about 6.25:1 on a weight to weight basis (preferably from about 0.1:1 to about 2:1, more preferably from about 0.15:1 to about 0.5:1, more preferably from about 0.17:1 to about 0.25:1, or more preferably about 0.2:1 on a weight to weight basis).

In yet further embodiments, when the at least one high potency sweetener is selected from the group consisting of a Luo Han Guo extract and/or a stevia extract; the at least one anti-foaming agent comprises polydimethylsiloxane and/or silicon dioxide; and the nutritive sweetener is fructose and/or sucrose, the ratio of the at least one high potency sweetener to the at least one anti-foaming agent in the sweetener composition is from about 2:1 to about 300:1 on a weight to weight basis (preferably from about 2:1 to about 200:1, more preferably from about 2:1 to about 150:1, more preferably from about 2:1 to about 100:1, even more preferably from about 2:1 to about 50:1 and even more preferably from about 2:1 to about 40:1 on a weight to weight basis) and the ratio of the at least one high potency sweetener to the nutritive sweetener in the sweetener composition is from about from about 0.02:1 to about 6.25:1 on a weight to weight basis (preferably from about 0.02:1 to about 3:1, more preferably from about 0.02:1 to about 2.75:1, more preferably from about 0.02:1 to about 2.5:1, more preferably from about 0.02:1 to about 1.5:1, even more preferably from about 0.02:1 to about 0.5:1, or even more preferably from about 0.03:1 to about 0.2:1 on a weight to weight basis).

In other further embodiments, when the at least one high potency sweetener is selected from the group consisting of a Luo Han Guo extract and/or a stevia extract, the at least one anti-foaming agent is selected from the group consisting of polydimethylsiloxane, a fatty acid ester, silicon dioxide, corn oil, coconut oil and cottonseed oil, and the nutritive sweetener is selected from the group consisting of sucrose, fructose, allulose, high fructose corn syrup, glucose and erythritol the ratio of the at least one high potency sweetener to the at least one anti-foaming agent in the sweetener composition is from about 2:1 to about 40:1 on a weight to weight basis and the ratio of the at least one high potency sweetener to the nutritive sweetener in the sweetener composition is from about from about 0.03:1 to about 0.2:1 on a weight to weight basis.

In other further embodiments, when the at least one high potency sweetener is a Luo Han Guo extract and/or a stevia extract, the at least one anti-foaming agent is polydimethylsiloxane and/or silicon dioxide and the nutritive sweetener is fructose and/or sucrose, the ratio of the at least one high potency sweetener to the at least one anti-foaming agent in the sweetener composition is from about 2:1 to about 40:1 on a weight to weight basis and the ratio of the at least one high potency sweetener to the nutritive sweetener in the sweetener composition is from about from about 0.03:1 to about 0.2:1 on a weight to weight basis. In further embodiments, the sweetener composition can further comprise a flavour enhancer, wherein the flavour enhancer is a high potency sweetener used in an amount below its sweetness threshold, and the high potency sweetener contains hydrophilic and hydrophobic structural moieties.

In further embodiments the flavour enhancer is a high potency sweetener that is selected from one or more of the group consisting of a natural high potency sweetener, a synthetic high potency sweetener that is a glycoside, or a synthetic high potency sweetener that is derived from an amino acid, provided that the flavour enhancer is different to the at least one high potency sweetener.

For example, when used in these embodiments, the flavour enhancer may be any of the substances hereinbefore defined as being a natural high potency sweetener, a synthetic high potency sweetener that is a glycoside, or a synthetic high potency sweetener that is derived from an amino acid.

The term “sweetness threshold” as used herein is the maximum concentration of a sweetener that is not perceived as sweet on its own. In respect of food and beverage products, the use of a sweetener at below its sweetness threshold is generally referred to as using the sweetener at a flavour level. In other words, the sweetener contributes to improving the overall sweetness and/or flavour of a food or beverage product, but does it while in an amount that would not provoke any sweet taste in a subject if given without the other ingredients of said food or beverage product.

Typically, the sweetener composition is formulated as a syrup, in powder form, in tablet form, as granules, or as a solution.

A further aspect relates to a product for human and/or animal consumption that comprises the sweetener composition hereinbefore defined. Typically, the product may be a food product, a beverage product, a pharmaceutical product, a nutritional product, a sports product, or a cosmetic product.

It will be appreciated that the amount of the sweetener composition of the invention present in a food product, a beverage product, a pharmaceutical product, a nutritional product, a sports product, or a cosmetic product, will depend upon the type and amount of sweetener present in the sweetener composition and the desired sweetness of the food or beverage product.

When the product is a food product, the product may be selected from the group consisting of a confectionary product, a dessert product, a cereal product, baked goods, frozen dairy products, meats, dairy products, condiments, snack bars, soups, dressings, mixes, prepared foods, baby foods, diet preparations, syrups, food coatings, dried fruit, sauces, gravies, and jams/jellies. When the sweetener composition hereinbefore defined is applied to any of the food product listed above, it may be applied as a coating or frosting formed on the surface of the product. This coating may be useful to improve the flavour of the food product as well as its shelf life.

When the product is a beverage product, the product may be selected from the group consisting of a concentrated beverage mix (e.g. MiO®, Dasani Drops® and powdered soft drinks), a carbonated beverage, a non-carbonated beverage, fruit-flavoured beverage, fruit-juice, tea, milk, coffee, and the like. In embodiments of the invention, it is preferred that the beverage product is not a carbonated beverage.

In certain embodiments, the beverage product comprises a nutritive sweetener at a concentration of less than 5000 ppm. Alternatively or additionally, the concentration of the nutritive sweetener in the beverage product is greater than or equal to 80 ppm.

In further embodiments, the beverage product has an acidic pH. Typically, the pH is from about 2.0 to about 6.5.

In certain embodiments, the beverage product comprises at least one high potency sweetener selected from the group consisting of a Luo Han Guo extract and an ent-kaurane sweetener (e.g. a stevia extract, glucosylated steviol glycosides, steviol glycosides, a glucosylated steviol glycoside, rubusoside, or a rebaudioside, such as rebaudioside A to F, M, N and X), and salts and/or solvates thereof; and at least one anti-foaming agent selected from the group consisting of polydimethylsiloxane, fatty acid esters, silicon dioxide and vegetable oils. For example, the at least one high potency sweetener comprises a Luo Han Guo extract; and the at least one anti-foaming agent comprises polydimethylsiloxane. In these embodiments, each of the listed terms has the meanings hereinbefore defined.

In further embodiments of the beverage product, the amount of polydimethylsiloxane is less than or equal to 10 ppm of the beverage.

In further embodiments of the product for human and/or animal consumption, the sweetness onset time and/or sweet taste linger has been shortened relative to a product comprising the high potency sweetener alone.

In a further aspect of the present invention, there is provided a use of at least one anti-foaming agent to shorten the sweetness onset time and/or the sweet taste linger of at least one high potency sweetener, relative to said at least one high potency sweetener alone. In this aspect, each of the terms listed uses the meanings hereinbefore defined.

A fourth aspect of the invention provides a method of making a sweetener composition according to the first aspect of the invention, said method comprising mixing at least one high potency sweetener with at least one anti-foaming agent.

The mixing of the various solid components together may be conducted using any known technique. Particular techniques for the mixing that may be mentioned include the use of a Turbula® mixer, a drum tumbler mixer or static mixers. Other mixing techniques may also be used.

In embodiments of this aspect, the method may further comprise mixing one or more nutritive sweeteners and/or one or more flavour enhancers together with the at least one high potency sweetener and the at least one anti-foaming agent, wherein said mixing occurs concomitantly with the mixing of the at least one high potency sweetener and the at least one anti-foaming agent, or sequentially following the mixing of the at least one high potency sweetener and the at least one anti-foaming agent, wherein the flavour enhancer is a high potency sweetener used in an amount below its sweetness threshold.

The following examples are exemplary only and are not intended to be limiting in any way.

### EXAMPLES

### Preparative Example 1—Formula A

An amount of 40 g of a commercially available Luo Han Guo powdered fruit extract (e.g. as obtained following the methods of producing such extracts described in U.S. Pat. No. 5,411,755 and U.S. Publication. No. 2006/0003053) was dissolved in 200 g of Milli-Q® water in a 500-mL beaker and 30 g of activated carbon (BG-HHM from Calgon Carbon Corporation) was added to the Luo Han Guo extract solution. After 2 hours, the activated carbon slurry was filtered through Whatman® #2 filter paper and the filtrate was sterile filtered into a tared freeze drying bottle and freeze-dried. The freeze-dried material was designated Formula A.

### Preparative Example 2—Formula B

Formula A (see preparative example 1) was blended in a 75:25 weight ratio with a commercially available stevia product consisting of approximately 75 wt % Rebaudioside A and 25 wt % stevioside. The resulting blend is herein designated as Formula B.

### Example 1

### Taste tests

### General Methods

For all taste tests conducted, the panellists were polled separately in order to avoid biasing the results. Panellists were not forced to choose a difference between the samples.

### Silicone Oil in Kool-Aid®

499.5 mL of a 0.2% solution of strawberry flavoured Kool-Aid^{RTM} was prepared in deionized water. To this solution 0.5 g of Formula A (a Luo Han Guo extract) was added to obtain a 1000 ppm solution of Formula A in a strawberry flavoured medium, which was labeled B. From this solution a 50 ppm solution of BIO-SIL® AF720E-20% food grade anti-foam emulsion was prepared as per the manufacturer's recommendation, which was labelled A. This yields a 10 ppm solution of polydimethylsiloxane, which is the Generally Recognised as Safe (GRAS) level established by the FDA for use in beverages.

Panellists were presented with a sample A, sample B, and water, and were asked to report on the difference in temporal profile between samples A and B, which are defined in Table 1. Panelists were instructed to rinse with water between tastings.

TABLE 1

| Substance Name | | |
|---|---|---|
| (Sample) | Weight Used (g) | Supplier |
| Formula A | 0.5 | Tate and Lyle |
| Strawberry Kool- | 0.1 | Kraft Foods Inc. |
| Aid^{RTM} | | |
| (B) (~500 g stock | | |
| solution ~250 g kept | | |
| as reference) | | |
| BIO-SIL^{RTM} AF720F | 0.0125 | Silicone & |
| (A) (~250 g | | Technical |
| prepared from | | Products LTD |
| stock) | | |

### Silicone Oil in Tea

499.5 g of iced black tea was obtained by brewing two 4 oz cups of tea in a Keurig® coffee maker and adding an equal weight of ice. To this solution 0.5 g of Formula A was added to obtain a 1000 ppm solution of Formula A sweetened iced tea. From this solution a 50 ppm solution containing BIO-SIL® AF720E-20% food grade anti-foam emulsion was prepared. This yields a 10 ppm solution of polydimethylsiloxane, which is the Generally Recognised as Safe (GRAS) level established by the FDA for use in beverages.

Before tasting, the five panellists were instructed to pay close attention to the overall temporal including sweetness onset and sweet linger, and asked to rinse with water between samples. Panellists were then presented with a sample of Formula A sweetened iced tea, water, and Formula A sweetened iced tea with silicone oil, as set out in Table 2. Panellists were then asked to describe the difference in temporal profile between the samples.

TABLE 2

| Substance Name | | |
|---|---|---|
| (Sample) | Weight Used (g) | Supplier |
| Formula A | 0.5 | Tate and Lyle |
| Classic English | The contents of 2 | Twinings of London |
| Breakfast Tea | Keurig^{RTM}-cups | |
| (~500 g stock | | |
| solution ~250 g kept | | |
| as reference) | | |
| BIO-SIL^{RTM} | 0.0125 | Silicone & |
| AF720F | | Technical Products |
| (~250 g prepared | | LTD |
| from stock) | | |

### Silicone Oil in Coffee

499.5 g of coffee was obtained by brewing two 8 oz cups of coffee in a Keurig® coffee maker. To this solution 0.5 g of Formula A was added to obtain a 1000 ppm solution of Formula A sweetened coffee. From this solution a 50 ppm solution containing BIO-SIL® AF720E-20% food grade anti-foam emulsion was prepared. This yields a 10 ppm solution of dimethylpolysiloxane, which is the GRAS level for use in beverages.

Before tasting, the five panellists were instructed to pay close attention to the overall temporal including sweetness onset and sweet linger. The panellists were then presented with a sample of Formula A sweetened coffee, water and Formula A sweetened coffee with silicone oil, as set out in Table 3. The panellists were then asked to describe the difference in temporal profile between the samples.

TABLE 3

| Substance Name | | |
|---|---|---|
| (Sample) | Weigh Used (g) | Supplier |
| Formula A | 0.5 | Tate and Lyle |
| Donut Shop Coffee | The contents of 2 | Green Mountain |
| (K-Cup) (~500 | Keurig^{RTM}-cups | |
| stock solution ~250 | | |
| kept as reference) | | |
| BIO-SIL^{RTM} | 0.0125 | Silicone & |
| AF720F | | Technical Products |
| (~250 g prepared | | LTD |
| from stock) | | |

### Results

### Silicone Oil in Kool-Aid®

One panellist reported that the silicone oil containing sample resulted in a faster sweetness onset than the control. Two panellists reported less sweet linger with the silicone oil containing sample. One of these panellists reported that the silicone oil containing sample more quickly reached maximal sweetness compared to control. This result was not exactly the same as faster onset. One panellist could not find a definitive difference between samples, although it was noted that the silicone oil containing sample had a thicker mouthfeel. The final panellist reported that the silicone oil sample was not sweet.

### Silicone Oil in Tea

Three of the five panellists reported that the anti-foaming agent treated sample reduced sweet linger. Three of the five panellists reported a faster sweetness onset in the anti-foamed sample. One panellist reported that the sample with the anti-foaming agent delayed onset.

### Silicone Oil in Coffee

Four of the five panellists reported that the anti-foaming agent treated sample reduced sweet linger. The fifth panellist reported that the anti-foamed sample displayed generally suppressed taste, possibly with less sweet linger. However the fifth panellist's preference was strongly in favour of the non-anti-foamed sample. One panellist reported a faster sweetness onset in the anti-foamed sample. A different panellist reported that the anti-foaming agent containing sample had a sweetness profile that better matched the coffee taste profile. No panellist reported that the control solution had a better temporal profile than the anti-foaming agent treated sample. All panellists reported that the anti-foaming agent treated sample was less sweet than the non-treated sample.

### Discussion

In the three systems tested, the silicone oil samples were perceived to have a temporal profile advantage over the control samples.

### Example 2

### Temporal Profile with Descriptive Panel

### Method

The temporal profile determined using a trained descriptive panel. Panellists had several orientation rounds of the test samples as well as other samples to familiarize themselves with the protocol and the samples. The tests were conducted as complete block designs in 3 replicates with the trained panel and were done over two testing days (one for each formula set). The presentation order was rotated. The solutions were served in 2 fluid ounce soufflé cups labelled with 3-digit codes. Panellists were instructed to sample the product by placing the sample in their mouths and swallowing or spitting out the sample immediately while starting their intensity rating for sweetness at the same lime using EyeQuestion. Intensity ratings for sweetness were collected for 2 minutes, Panellists had a two minute wait time between samples and at least a 10 minute break in-between repetitions. Panellists cleaned their palates with bottled water and unsalted crackers. Time to peak was compared across samples to determine if addition of anti-foam or fructose can improve time course of Formula A.

The maximum intensity of each panellist for each sample was determined, and their overall temporal profile data for that sample was normalized as % of maximum. Once normalized data has been calculated, an averaged response as normalized % of maximum for each time point was calculated and plotted for each sample.

The samples produced are listed below in Tables 4 and 5.

TABLE 4

| | Sample 1 | Sample 2 | Sample 3 | Sample 4 | Sample 5 | Sample 6 |
|---|---|---|---|---|---|---|
| | 160 ppm | 160 ppm | 4500 ppm | 4500 ppm | Formula A | Formula A |
| | fructose with | fructose no | fructose no | fructose with | control no | control no |
| Ingredient | acid/buffer | acid/buffer | acid/buffer | acid/buffer | acid/buffer | acid/buffer |
| Water | 1998.44 g | 1998.88 | 1990.20 | 1989.76 | 1999.20 | 1998.76 |
| | (99.88 wt %) | (99.94 wt %) | (99.51 wt %) | (99.49 wt %) | (99.96 wt %) | (99.89 wt %) |
| Phosphoric | 0.34 | 0.00 | 0.00 | 0.34 | 0.00 | 0.34 |
| Acid, 85% | (0.017 wt %) | | | (0.017 wt %) | | (0.017 wt %) |
| sin | | | | | | |
| Sodium | 0.1 | 0.00 | 0.00 | 0.1 | 0.00 | 0.1 |
| citrate | (0.005 wt %) | | | (0.005 wt %) | | (0.005 wt %) |
| Formula A | 0.8 | 0.80 | 0.80 | 0.80 | 0.80 | 0.80 |
| | (0.04 wt %) | (0.04 wt %) | (0.04 wt %) | (0.04 wt %) | (0.04 wt %) | (0.04 wt %) |
| Crystalline | 0.320 | 0.320 | 9.00 | 9.00 | 0.00 | 0.00 |
| Fructose | (0.016 wt %) | (0.016 wt %) | (0.45 wt %) | (0.45 wt %) | | |
| Total | 2000 g | 2000 g | 2000 g | 2000 g | 2000 g | 2000 g |

TABLE 5

| | Sample 1 | Sample 2 | Sample 3 | Sample 4 | Sample 5 | Sample 6 |
|---|---|---|---|---|---|---|
| | 160 ppm | 160 ppm | 4500 ppm | 4500 ppm | Formula A | Formula A |
| | fructose with | fructose no | fructose no | fructose with | control no | control no |
| Ingredient | acid/buffer | acid/buffer | acid/buffer | acid/buffer | acid/buffer | acid/buffer |
| Water | 1998.34 g | 1998.78 | 1990.10 | 1989.66 | 1999.20 | 1997.76 |
| | (99.88 wt %) | (99.94 wt %) | (99.51 wt %) | (99.48 wt %) | (99.96 wt %) | (99.89 wt %) |
| Phosphoric | 0.34 | 0.00 | 0.00 | 0.34 | 0.00 | 0.34 |
| Acid, 85% | (0.017 wt %) | | | (0.017 wt %) | | (0.017 wt %) |
| sin | | | | | | |
| Sodium | 0.1 | 0.00 | 0.00 | 0.1 | 0.00 | 0.1 |
| citrate | (0.005 wt %) | | | (0.005 wt %) | | (0.005 wt %) |
| Formula A | 0.8 | 0.80 | 0.80 | 0.80 | 0.80 | 0.80 |
| | (0.04 wt %) | (0.04 wt %) | (0.04 wt %) | (0.04 wt %) | (0.04 wt %) | (0.04 wt %) |
| Crystalline | 0.320 | 0.320 | 9.00 | 9.00 | 0.00 | 0.00 |
| Fructose | (0.016 wt %) | (0.016 wt %) | (0.45 wt %) | (0.45 wt %) | | |
| Silicone Oil | 0.10 | 0.10 | 0.10 | 0.10 | 0.00 | 0.00 |
| | (0.005 wt %) | (0.005 wt %) | (0.005 wt %) | (0.005 wt %) | | |
| Total | 2000 g | 2000 g | 2000 g | 2000 g | 2000 g | 2000 g |

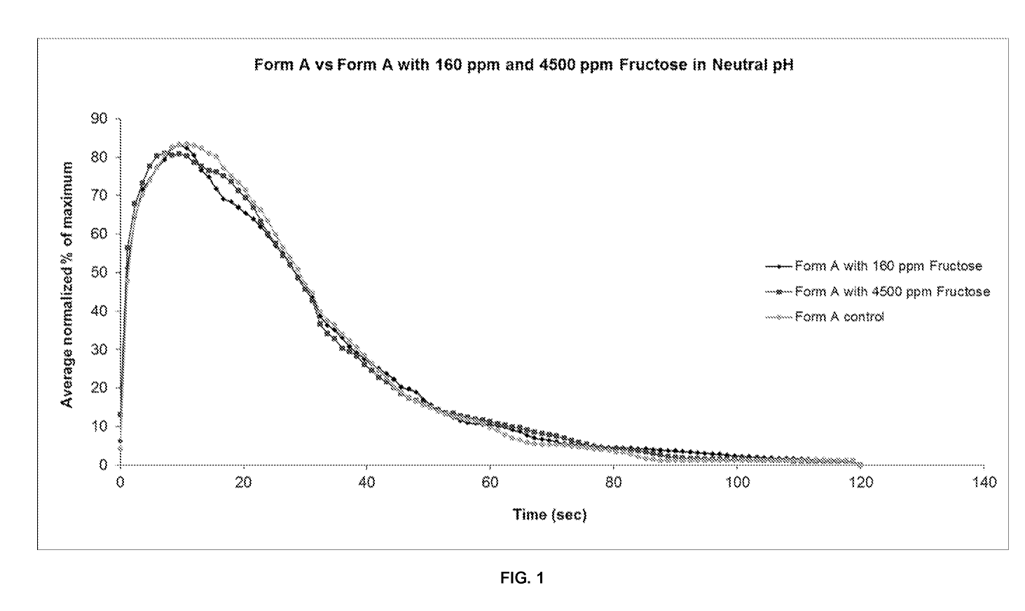

The results of Example 2 are graphically represented in FIGS. 1 to 8.

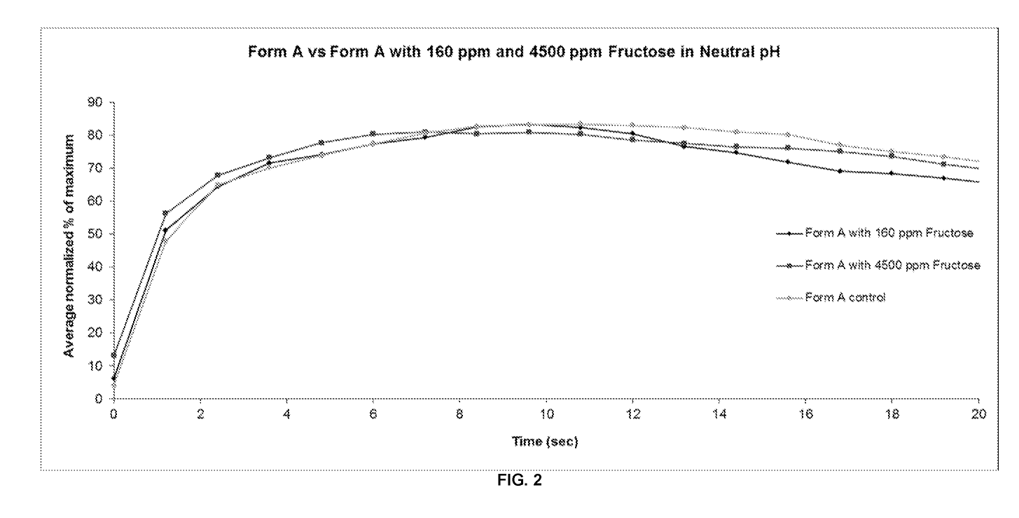

Fructose levels of 4500 ppm to Formula A in neutral pH to changes the temporal profile by reducing sweetness onset based on the difference in response for the first 20 seconds (see FIGS. 1 and 2). The addition of 160 ppm levels of fructose to Formula A in neutral pH did not reduce sweetness onset (similar to what was previously observed with 80 ppm fructose to Formula A in neutral pH). Neither the 160 ppm or 4500 ppm fructose addition reduced sweetness linger (see FIG. 1).

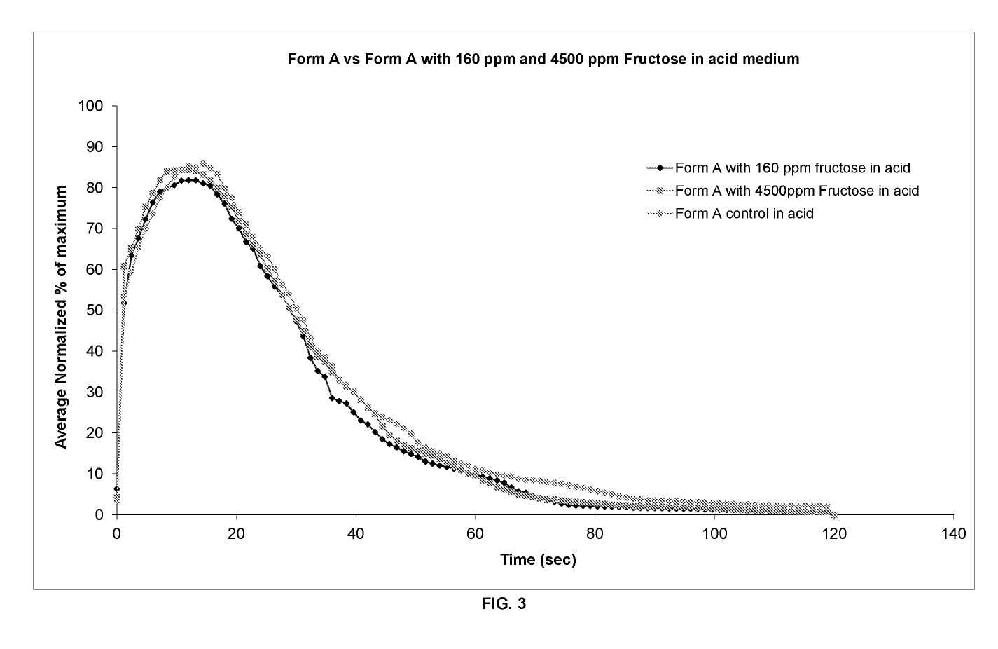

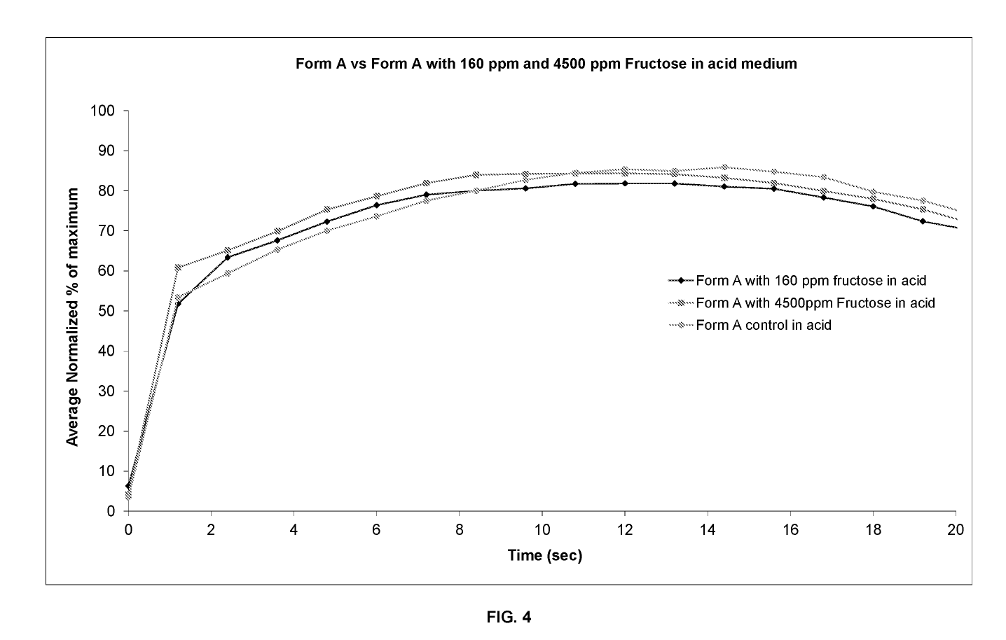

The addition of 160 ppm and 4500 ppm levels of fructose to Formula A in an acid medium changed the temporal profile related to improving sweetness onset based on the difference in response for first 20 seconds (see FIGS. 3 and 4). There was no difference in sweetness linger with the addition of fructose to Formula A (see FIG. 3).

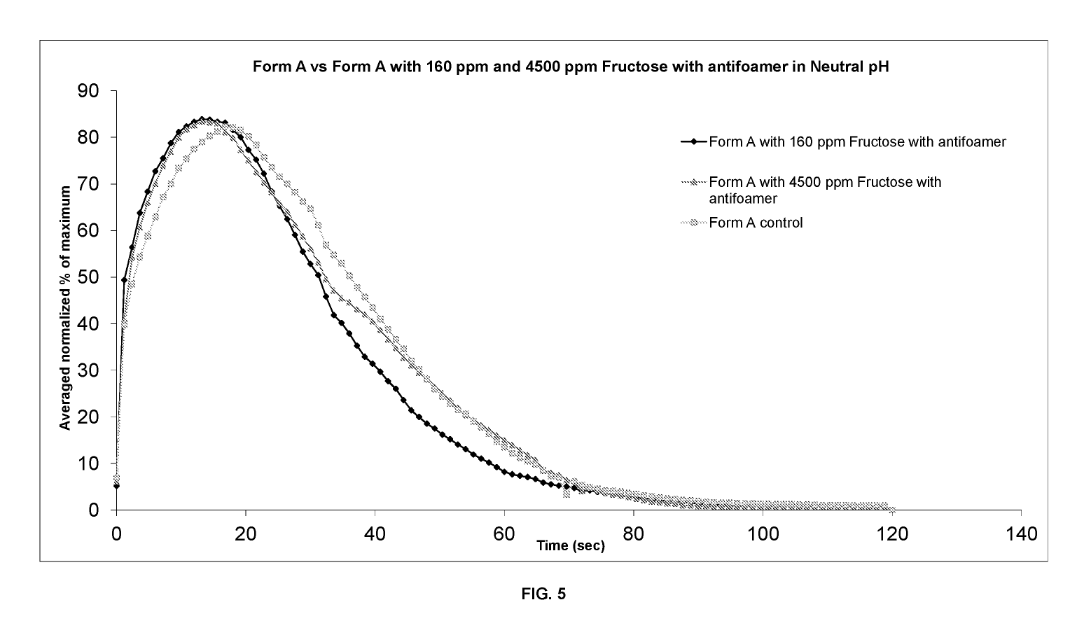

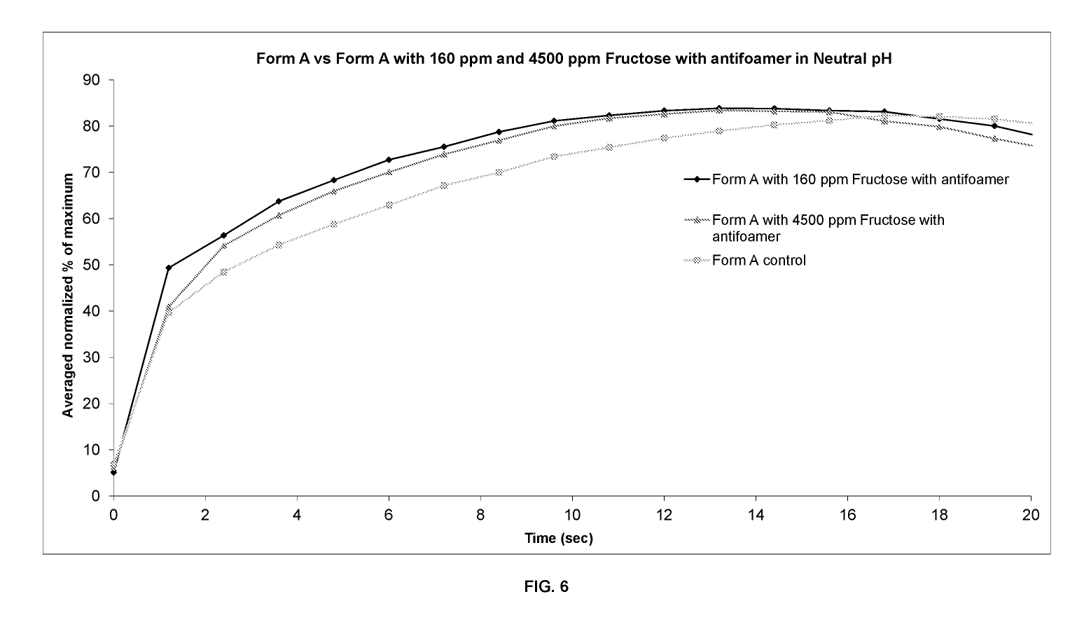

When silicone oil (anti-foaming agent) was added to both the 160 ppm and 4500 ppm levels of fructose with Formula A in neutral pH, there was a change in the sweetness linger profile of Formula A, with a reduced linger intensity after the peak in sweetness intensity (see FIGS. 5 and 6). The effect was more dramatic for the 160 ppm fructose addition versus the 4500 ppm (the 4500 ppm loses its linger difference over control after 40 seconds; see FIG. 5). Both the 160 ppm and 4500 ppm prototypes have improved overall sweetness onset profiles relative to the Formula A control based on the difference in response for the first 20 seconds (see FIG. 6).

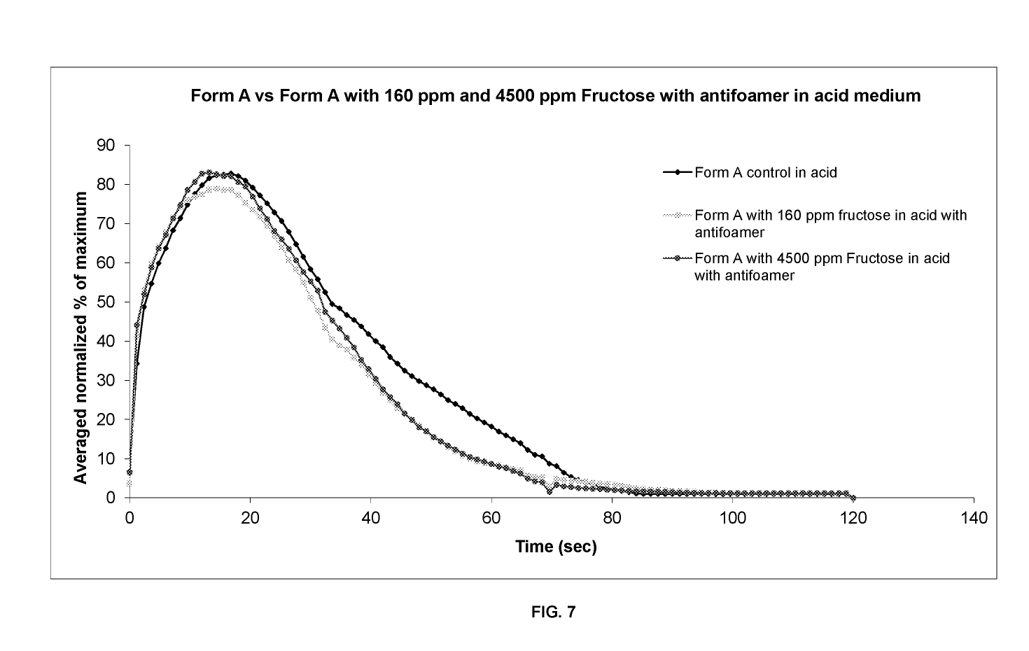

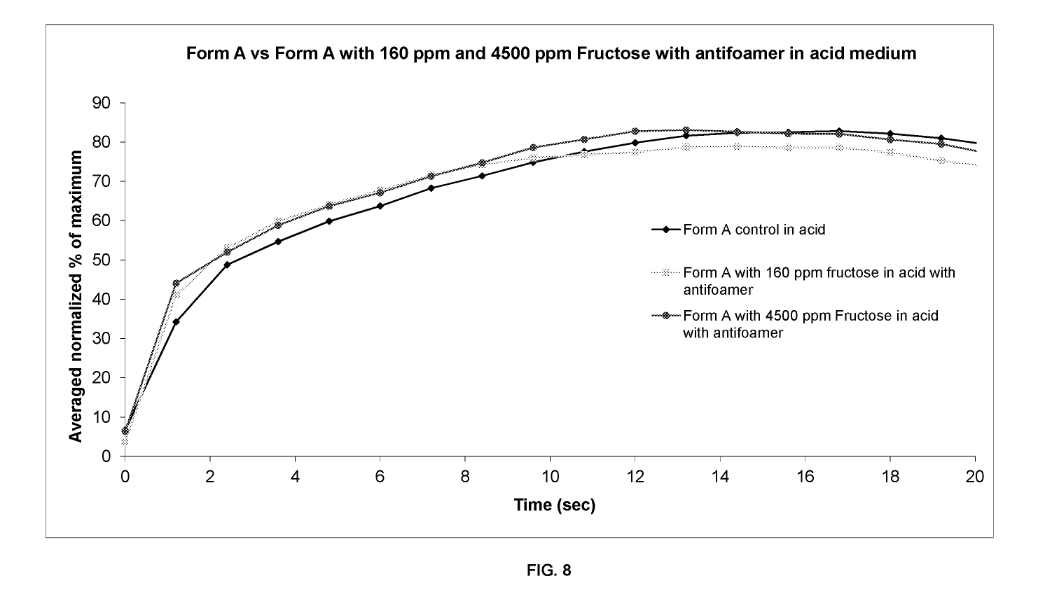

Silicone oil (anti-foamer) added to both the 160 ppm and 4500 ppm levels of fructose with Formula A in an acid medium changes the sweetness linger profile of Formula A, with a reduction in linger intensity after the peak in sweetness intensity (see FIGS. 7 and 8). Both the 160 ppm and 4500 ppm prototypes have improved overall sweetness onset profiles relative to the Formula A control based on the difference in response for the first 20 seconds (see FIG. 8).

### Example 3

### Grape Favoured System with Anti-foam and Anti-foam with Fructose

The temporal profile was completed with a trained descriptive panel. Panellists had several orientation rounds of the test samples to familiarize themselves with the protocol and the samples. The tests were conducted as complete block designs in 3 replicates with the trained panel and were done over three testing days. The presentation order was rotated. The solutions were served in 2 fluid ounce soufflé cups labelled with 3-digit codes, and panellists will receive 40 ml of each sample and were instructed to use half of the sample for sweetness temporal profile, and the remaining half for grape flavour temporal profile. Panellists were instructed to sample the product by placing the sample in their mouths and swallowing or spitting out the sample immediately while starting their intensity rating for sweetness at the same time using EyeQuestion. Intensity ratings for sweetness were collected for 2 minutes. Panellists had a two minute wait period to clean their palate before rating strawberry flavour temporal profile. After the two minute wait, panellists were instructed to sample the product by placing the sample in their mouths and swallowing or spitting out the sample immediately while starting their intensity rating for strawberry flavour at the same time using EyeQuestion. Panellists had a two minute wait time between samples and at least a 15 minute break in-between repetitions. Panellists will clean their palates with Sugar water, RO water, and unsalted crackers.

The maximum intensity of each panellist for each sample was determined, and their overall temporal profile data for that sample was normalized as % of maximum. Once normalized data is calculated, and averaged response calculated as normalized % of maximum for each time point was calculated and plotted for each sample.

### Products

The products tested are listed below in Table 6. PFS refers to Formula A.

TABLE 6

| | | | | | PFS anti- |
|---|---|---|---|---|---|
| | | Sugar | PFS | | foam |
| | | Grams | Grams | PFS anti-foam | fructose |
| INGREDIENT | SUPPLIER | (%) | (%) | Grams (%) | Grams (%) |
| Water | | 1347.0000 | 1495.8000 | 1495.7250 | 1488.9750 |
| | | (89.80) | (99.72) | (99.72) | (99.27) |
| Formula A | T&L | 0 | 1.2000 | 1.2000 | 1.2000 |
| | | (0) | (0.08) | (0.08) | (0.08) |
| Silicone Oil | Silicone | 0 | 0 | 0.0750 | 0.0750 |
| | and | (0) | (0) | (0.005) | (0.005) |
| | Technical | | | | |
| | Products | | | | |
| Grape Kool- | | 3.0000 | 3.0000 | 3.0000 | 3.0000 |
| Aid^{RTM} | | (0.2) | (0.2) | (0.2) | (0.2) |
| powder | | | | | |
| Sucrose | | 150.000 | 0 | 0 | 0 |
| | | (10) | (0) | (0) | (0) |
| Fructose | | 0 | 0 | 0 | 6.7500 |
| | | (0) | (0) | (0) | (0.45) |
| TOTAL | | 1500 | 1500 | 1500 | 1500 |
| | | (100) | (100) | (100) | (100) |

### Results

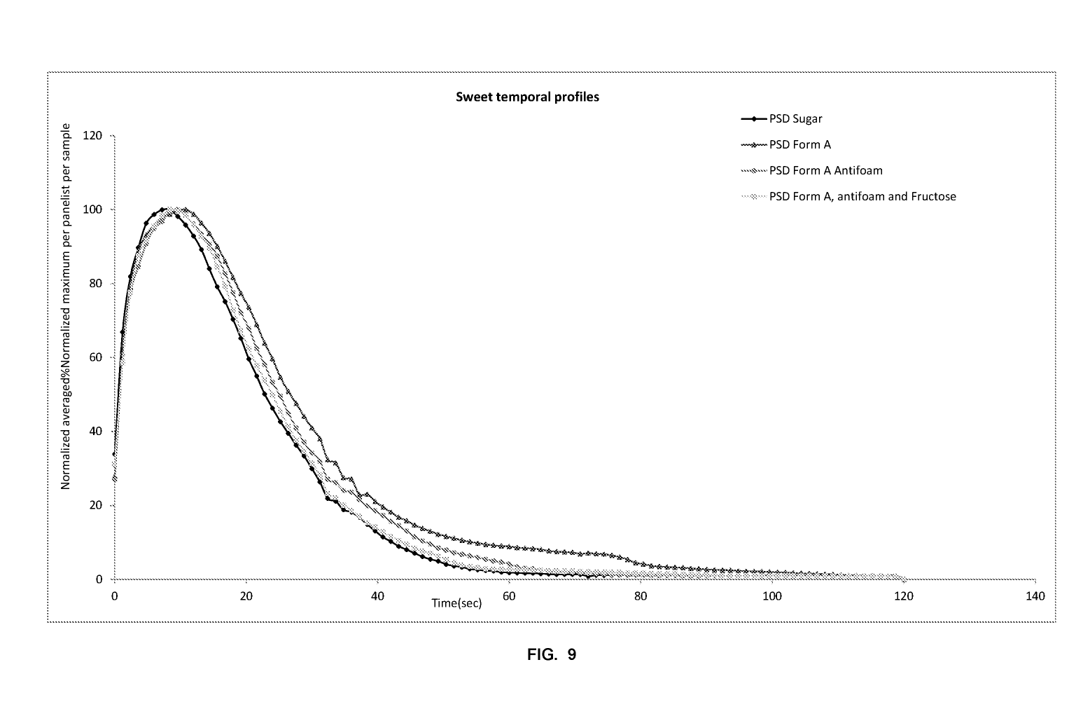

The results of Example 3 are graphically represented in FIGS. 9 to 12.

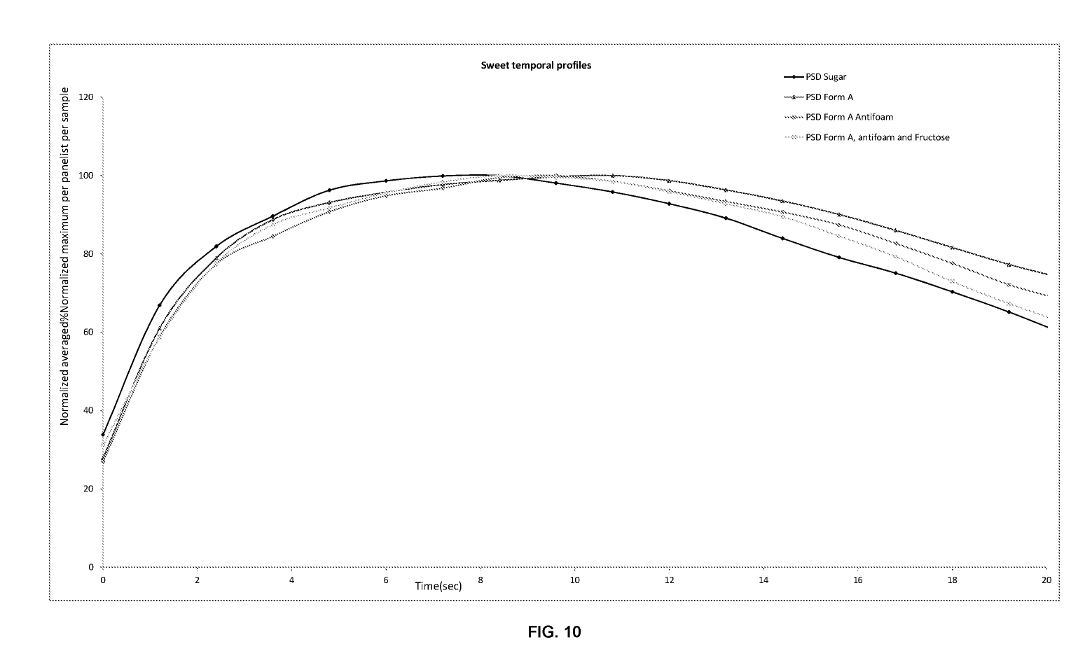

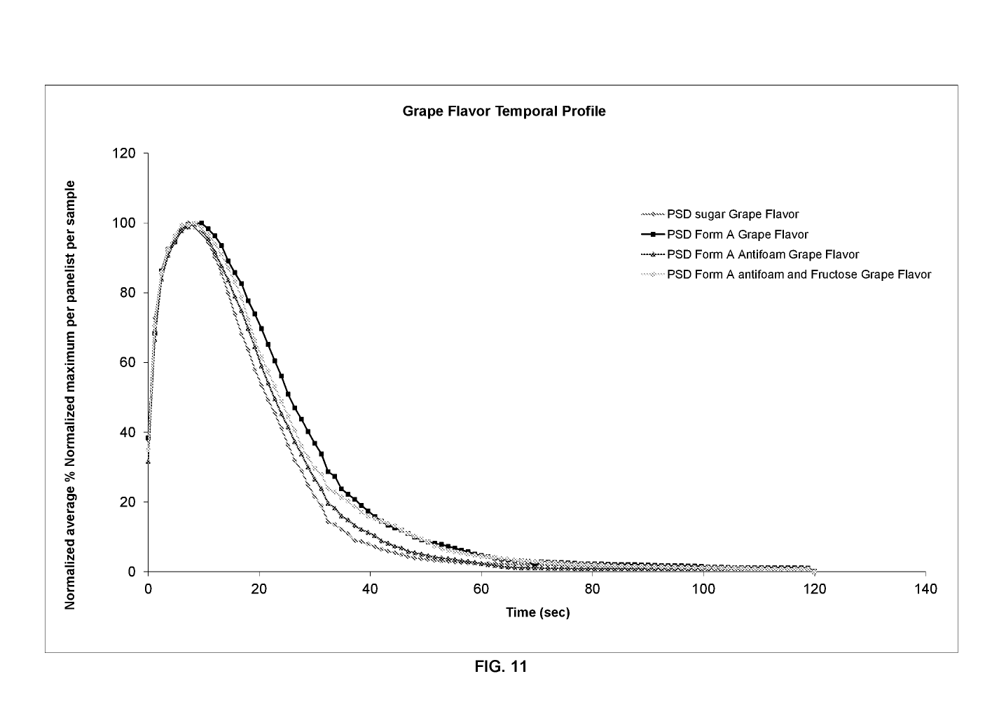

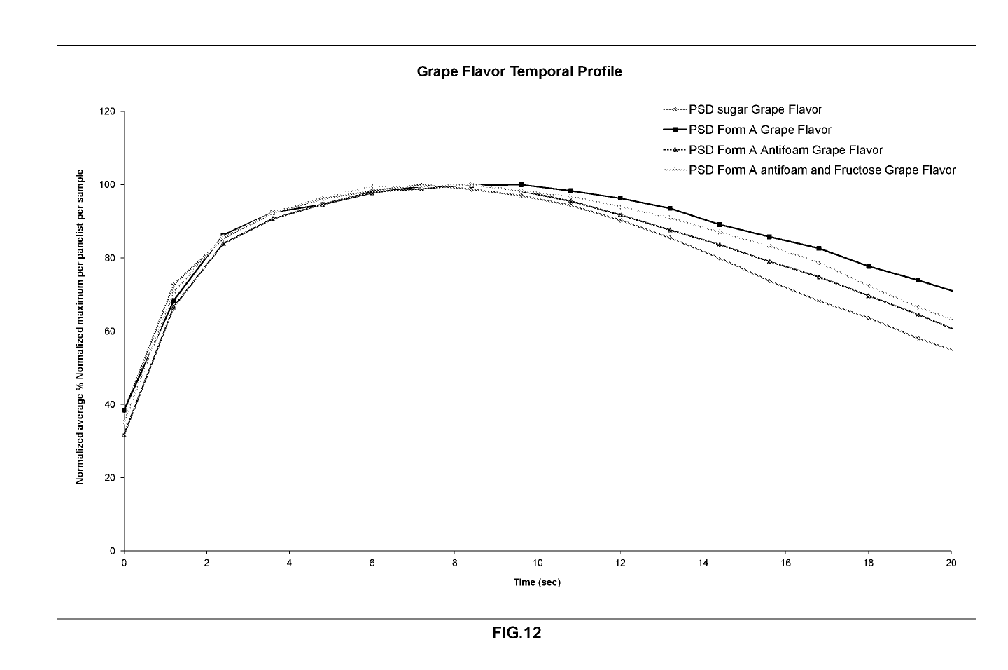

Temporal profile onset for sweetness and grape flavour are more aligned for soft drinks sweetened with sugar in comparison to soft drinks sweetened with Formula A. The addition of an anti-foam with fructose more closely aligned the temporal profile between grape flavour and sweetness. In comparing just the sweetness temporal profile across samples, the soft drinks sweetened with Formula A had a later onset and increased linger (see FIGS. 9 and 10). Addition of anti-foam, and anti-foam with fructose reduced sweetness onset delay and linger. Across the samples for grape flavour temporal profile, the addition of the anti-foam, and anti-foam with fructose reduced grape flavour temporal profile linger so that it was closer to the sugar control grape flavour temporal profile (see FIGS. 11 and 12).

### Example 4

### Temporal Profile with Various Anti-foams

Anti-foam ingredients were evaluated for their effectiveness of reducing temporal profile linger. This study was conducted to explore the interaction of Formula C (a Monk fruit extract and steviol glycoside blend) with and without anti-foam on temporal profile.

The temporal profile was completed with a trained descriptive panel. Panellists had several orientation rounds of the test samples as well as other samples to familiarize themselves with the protocol and the samples. During the first three days of orientation, panellists' results were reviewed to refresh panel on proper technique and assessment of temporal profile.

The tests were conducted as complete block designs in 3 replicates with the trained panel and were done over two testing days (one for each formula set). The presentation order was rotated. The solutions were served in 2 fluid ounce soufflé cups labelled with 3-digit codes. Panellists were instructed to sample the product by placing the sample in their mouths and swallowing or spitting out the sample immediately while starting their intensity rating for sweetness at the same time using EyeQuestion. Intensity ratings for sweetness were collected for 2 minutes. Panellists had a two minute wait time between samples and at least a 10 minute break in-between repetitions. Panellists cleaned their palates with bottled water and unsalted crackers.

The maximum intensity of each panellist for each sample was determined, and their overall temporal profile data for that sample were normalized as % of maximum. Once normalized data is calculated, averaged response was calculated as normalized % of maximum for each time point were normalized as a % of averaged normalized maximum and plotted for each sample. The products tested are summarised in Table 7.

Pure silicone oil is 100% polydimethylsiloxane, C-2300 K is a proprietary blend of fatty acid esters, “MD-20-S FG” is a material that comprises 20 wt % of polydimethylsiloxane and silicon dioxide (as anti-foaming agents) and 80 wt % maltodextrin, and MD 3500 is a vegetable oil and silicon dioxide based anti-foam with maltodextrin. Maltodextrin is used in the last two anti-foams to generate a solid composition of the anti-foam. When used herein, “TEMP” refers to the combination of a sugar with an anti-foaming agent. Therefore, the term “TEMP” may be applied to each of the examples containing sucrose in combination with C-2300 K, MD-20-S FG, MD 3500 or pure silicone oil. However, in the figures depicting this example, “TEMP” refers to the combination of sucrose with silicone and silica gel (i.e. MD-20-S FG).

TABLE 7

| | | | Silicone | | Pure | |
|---|---|---|---|---|---|---|
| | | Formula C | and Silica | Non- | Silicone | Natural |
| | | Grams | Gel (TEMP) | Silicone | Oil | Anti-foam |
| Ingredient | Supplier | (%) | Grams (%) | Grams (%) | Grams (%) | Grams (%) |
| Water | | 1499.4000 | 1491.8250 | 1491.7500 | 1491.900 | 1491.900 |
| | | (99.96) | (99.455) | (99.450) | (99.460) | (99.460) |
| Formula C | T&L | 0.60000 | 0.60000 | 0.60000 | 0.600 | 0.600 |
| | | (0.04) | (0.04000) | (0.0400) | (0.040) | (0.040) |
| Sucrose | | 0 | 7.500 | 7.500 | 7.500 | 7.500 |
| | | (0) | (0.500) | (0.500) | (0.500) | (0.500) |
| C-2300 K | New | 0 | 0 | 0.1500 | 0 | 0 |
| | London | (0) | (0) | (0.0100) | (0) | (0) |
| | Chemicals | | | | | |
| MD-20-S | Magrabar | 0 | 0.0750 | 0 | 0 | 0 |
| FG | | (0) | (0.005) | (0) | (0) | (0) |
| Pure | Clearco | 0 | 0 | 0 | 0.015 | 0 |
| Silicone | Products | (0) | (0) | (0) | (0.001) | (0) |
| Fluid | | | | | | |
| MD 3500 | Magrabar | 0 | 0 | 0 | 0 | 0.300 |
| | | (0) | (0) | (0) | (0) | (0.020) |
| TOTAL | | 1500 | 1500 | 1500 | 1500 | 1500 |
| | | (100) | (100) | (100) | (100) | (100) |

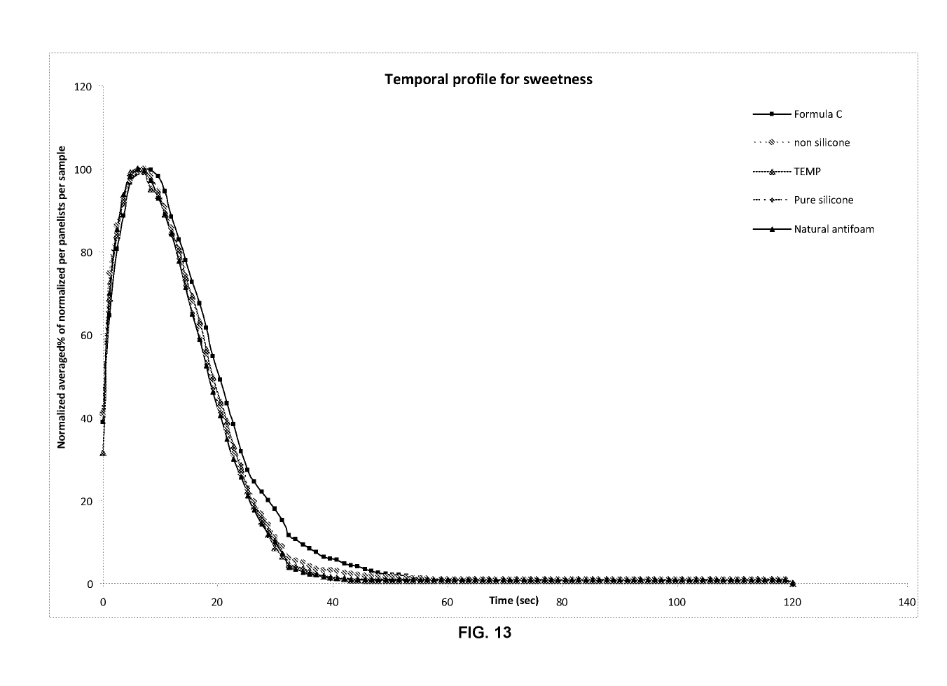

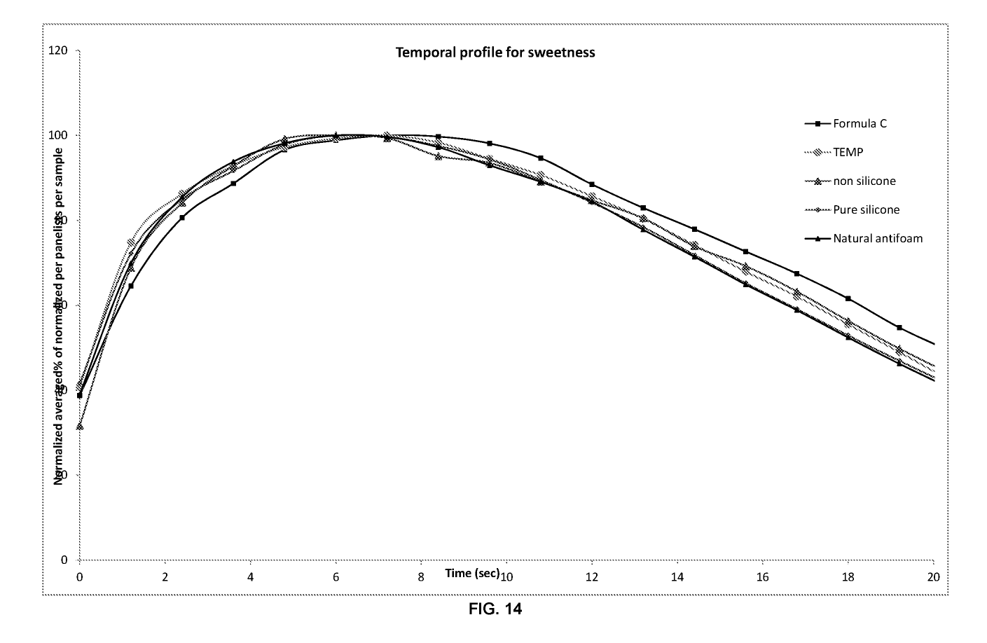

The results of Example 4 are graphically represented in FIGS. 13 and 14.

The addition of each of the anti-foams improved the temporal profile of Formula C. For all anti-foam containing prototypes tested, there was a reduction in temporal linger and a slight shift in temporal onset over Formula C alone. Therefore, a number of quite different anti-foams can be used to improve the temporal performance of a high potency sweetener, such as Formula C.

1. A sweetener composition comprising:
at least one high potency sweetener; and
at least one anti-foaming agent, wherein
the at least one high potency sweetener contains hydrophilic and hydrophobic structural moieties.

2. The composition of claim 1, wherein the at least one high potency sweetener is selected from the group consisting of a natural high potency sweetener, a synthetic high potency sweetener that is a glycoside, or a synthetic high potency sweetener that is derived from an amino acid.

3. The composition of claim 1, wherein the at least one high potency sweetener is selected from the group consisting of abrusoside A, alitame, aspartame, baiyunoside, brazzein, curculin, cyclocarioside I, glycyphyllin, glycyrrhizic acid, a glucosylated steviol glycoside, hernandulcin, N-[N-[3-(3-hydroxy-4- methoxyphenyl)propyl]-L-[alpha]-aspartyl]-L-phenylalanine 1-methyl ester, N-[N-[3-(3- hydroxy-4-methoxyphenyl)-3-methylbutyl]-L-[alpha]-aspartyl]-L-phenylalanine 1-methyl ester, a Luo Han Guo extract, mabinlin, N-[N-[3-(3-methoxy-4-hydroxyphenyl)propyl]-L-[alpha]-aspartyl]-L-phenylalanine 1-methyl ester, monatin, monellin, mukurozioside, neohesperidin dihydrochalcone, neotame, osladin, periandrins, phlomisosides, phloridzin, phyllodulcin, polypodoside A, pterocaryoside A, pterocaryoside B, an ent-kaurane sweetener, thaumatin and trilobatin, and salts and/or solvates thereof.

4. The composition of claim 3, wherein the at least one high potency sweetener is selected from the group consisting of abrusoside A, aspartame, baiyunoside, cyclocarioside I, glycyphyllin, glycyrrhizic acid, a glucosylated steviol glycoside, a Luo Han Guo extract, monatin, mukurozioside, neohesperidin dihydrochalcone, neotame, osladin, periandrins, phlomisosides, phloridzin, polypodoside A, pterocaryoside A, pterocaryoside B, an ent-kaurane sweetener and trilobatin, and salts and/or solvates thereof.

5. The composition of claim 4, wherein the at least one high potency sweetener is selected from the group consisting of a Luo Han Guo extract, neohesperidin dihydrochalcone, neotame, a glucosylated steviol glycoside, rubusoside, a steviol glycoside and a stevia extract, and salts and/or solvates thereof.

6. The composition of claim 5, wherein the at least one high potency sweetener comprises a Luo Han Guo extract and/or a stevia extract.

7. The composition of claim 1, further comprising a nutritive sweetener.

8. The composition of claim 7, wherein the nutritive sweetener is one or more selected from the group consisting of a 3- to 12-carbon sugar alcohol, a monosaccharide and a sweet disaccharide.

9. The composition of claim 8, wherein the nutritive sweetener is one or more selected from the group consisting of allose, deoxyribose, erythrulose, galactose, gulose, idose, lyxose, mannose, ribose, tagatose, talose, xylose, erythrose, fuculose, gentiobiose, gentiobiulose, isomaltose, isomaltulose, kojibiose, lactulose, altrose, laminaribiose, arabinose, leucrose, fucose, rhamnose, sorbose, maltulose, mannobiose, mannosucrose, melezitose, melibiose, melibiulose, nigerose, raffinose, rutinose, rutinulose, sophorose, stachyose, threose, trehalose, trehalulose, turanose, xylobiose, sucrose, fructose, glucose, glucose-fructose syrup, high fructose corn syrup, invert sugar, allulose, arabitol, erythritol, glycerol, hydrogenated starch hydrolysate, isomalt, lactitol, maltitol, mannitol, sorbitol and xylitol.

10. The composition of claim 9, wherein the nutritive sweetener is one or more selected from the group consisting of sucrose, fructose, allulose, high fructose corn syrup, glucose and erythritol.

11. The composition of claim 10, wherein the nutritive sweetener is fructose and/or sucrose.

12. The composition of claim 7, wherein the ratio of the at least one high potency sweetener to the nutritive sweetener is from about 0.05:1 to about 6.25:1 on a weight to weight basis.

13. The composition of claim 12, wherein the ratio of the at least one high potency sweetener to the nutritive sweetener is greater than about 0.1:1 and less than or equal to about 2:1 on a weight to weight basis.

14. The composition of claim 13, wherein the ratio of the at least one high potency sweetener to the nutritive sweetener is from about 0.15:1 to about 0.5:1 on a weight to weight basis.

15. The composition of claim 14, wherein the ratio of the at least one high potency sweetener to the nutritive sweetener is from about 0.17:1 to about 0.25:1 on a weight to weight basis.

16. The composition of claim 15, wherein the ratio of the at least one high potency sweetener to the nutritive sweetener is about 0.2:1 on a weight to weight basis.

17. The composition of claim 1, wherein the at least one anti-foaming agent comprises one or more selected from the group consisting of a fatty acid, a fatty acid ester, a silicone oil, silicon dioxide, an alkyl-substituted silicon dioxide, lecithin, a vegetable oil, propylene glycol mono and diesters of fatty acids, propylene glycol alginate, calcium alginate, mineral oil, odourless light petroleum hydrocarbons, petrolatum, petroleum waxes, synthetic isoparaffinic petroleum hydrocarbons, synthetic petroleum wax, paraffin wax, microcrystalline wax, tallow, oxidized tallow, sulfated tallow, oleomargarine, lard, butter, oxystearin, a fatty acid metal salt, ethylene oxide polymer, copolymer condensates of ethylene oxide and propylene oxide, polyethylene glycol, polypropylene glycol, polyethylene glycol (400) dioleate, sorbitan monostearate, polysorbate 60 (polyoxyethylene (20) sorbitan monostearate), polysorbate 65 (polyoxyethylene (20) sorbitan tristearate), polysorbate 80 (polyoxyethylene (20) sorbitan monooleate), n-butoxypolyoxyethylene polyoxypropylene glycol, polyoxyethylene (600) dioleate, polyoxyethylene (600) monoricinoleate and polyoxyethylene (40) monostearate.

18. The composition of claim 17, wherein the at least one anti-foaming agent comprises one or more selected from the group consisting of a fatty acid, a fatty acid ester, a silicone oil, silicon dioxide, an alkyl-substituted silicon dioxide, lecithin, a vegetable oil, propylene glycol mono and diesters of fatty acids, propylene glycol alginate and calcium alginate.

19. The composition of claim 18, wherein the at least one anti-foaming agent comprises one or more selected from the group consisting of decanoic acid, oleic acid, capric acid, caprylic acid, lauric acid, myristic acid, palmitic acid, stearic acid, a fatty acid ester, a silicone oil, silicon dioxide, an alkyl-substituted silicon dioxide, corn oil, coconut oil and cottonseed oil.

20. The composition of claim 19, wherein the at least one anti-foaming agent comprises one or more selected from the group consisting of polydimethylsiloxane, a fatty acid ester, silicon dioxide, corn oil, coconut oil and cottonseed oil.

21. The composition of claim 20, wherein the at least one anti-foaming agent comprises polydimethylsiloxane and/or silicon dioxide.

22. The composition of claim 1, wherein the at least one anti-foaming agent has a hydrophilic-lipophilic balance value of less than or equal to 10.

23. The composition of claim 1, wherein the ratio of the at least one high potency sweetener to the at least one anti-foaming agent is from about 0.004:1 to about 300:1 on a weight to weight basis.

24. The composition of claim 23, wherein the ratio of the at least one high potency sweetener to the at least one anti-foaming agent is from about 8:1 to about 250:1 on a weight to weight basis.

25. The composition of claim 24, wherein the ratio of the at least one high potency sweetener to the at least one anti-foaming agent is from about 20:1 to about 150:1 on a weight to weight basis.

26. The composition of claim 25, wherein the ratio of the at least one high potency sweetener to the at least one anti-foaming agent is from about 40:1 to about 100:1 on a weight to weight basis.

27. The composition of claim 1, further comprising a flavour enhancer, wherein
the flavour enhancer is a high potency sweetener used in an amount below its sweetness threshold, and
the high potency sweetener contains hydrophilic and hydrophobic structural moieties.

28. The composition of claim 27, wherein the flavour enhancer is a high potency sweetener that is selected from one or more of the group consisting of a natural high potency sweetener, a synthetic high potency sweetener that is a glycoside, or a synthetic high potency sweetener that is derived from an amino acid, provided that the flavour enhancer is different to the at least one high potency sweetener.

29. The composition of claim 27, wherein the flavour enhancer is one or more selected from the group consisting of a natural high potency sweetener, a synthetic high potency sweetener that is a glycoside, or a synthetic high potency sweetener that is derived from an amino acid.

30. The composition of claim 7, wherein:
the at least one high potency sweetener comprises Luo Han Guo extract and steviol glycosides;
the at least one anti-foaming agent comprises polydimethylsiloxane and/or silicon dioxide; and
the nutritive sweetener is sucrose.

31. The composition of claim 1, wherein the composition is formulated as a syrup, in powder form, in tablet form, as granules, or as a solution.

32. A product for human and/or animal consumption, comprising a composition according to claim 1.

33. The product of claim 32, wherein the product is a food product, a beverage product, a pharmaceutical product, a nutritional product, a sports product, or a cosmetic product.

34. The product of claim 33, wherein the product is a food product.

35. The product of claim 34, wherein the food product is selected from the group consisting of a confectionary product, a dessert product, a cereal product, baked goods, frozen dairy products, meats, dairy products, condiments, snack bars, soups, dressings, mixes, prepared foods, baby foods, diet preparations, syrups, food coatings, a frosting, dried fruit, sauces, gravies, and jams/jellies.

36. The product of claim 33, wherein the product is a beverage product.

37. The product of claim 36, wherein the beverage product is selected from the group consisting of a concentrated beverage mix, a carbonated beverage, a non-carbonated beverage, fruit-flavoured beverage, fruit-juice, tea, milk, coffee, and combinations thereof.

38. The product of claim 36, wherein the beverage product comprises a nutritive sweetener at a concentration of less than 5000 ppm.

39. The product of claim 36, wherein the concentration of the nutritive sweetener in the beverage product is greater than or equal to 80 ppm.

40. The product of claim 36, wherein the beverage product has an acidic pH.

41. The product of claim 40, wherein the pH is from about 2.0 to about 6.5.

42. The product of claim 36, wherein the beverage product comprises:
at least one high potency sweetener selected from the group consisting of a Luo Han Guo extract and an ent-kaurane sweetener, and salts and/or solvates thereof; and
at least one anti-foaming agent selected from the group consisting of polydimethylsiloxane, fatty acid esters, silicon dioxide and vegetable oils.

43. The product of claim 42, wherein: the at least one high potency sweetener comprises a Luo Han Guo extract and/or a stevia extract; and
the at least one anti-foaming agent comprises polydimethylsiloxane and/or silicon dioxide.

44. The product of claim 42, wherein:
the at least one high potency sweetener comprises a Luo Han Guo extract and/or a stevia extract; and
the at least one anti-foaming agent comprises polydimethylsiloxane and/or silicon dioxide; and
the product further comprises sucrose.

45. The product of claim 42, wherein the amount of polydimethylsiloxane is less than or equal to 10 ppm of the beverage.

46. The product of claim 32, wherein the sweetness onset time and/or sweet taste linger has been shortened relative to a product comprising the high potency sweetener alone.

47-57. (canceled)

58. A method of making a sweetener composition according to claim 1, said method comprising mixing at least one high potency sweetener with at least one anti-foaming agent.

59. The method of claim 58, wherein the method further comprises mixing one or more nutritive sweeteners and/or one or more flavour enhancers together with the at least one high potency sweetener and the at least one anti-foaming agent, wherein: said mixing occurs concomitantly with the mixing of the at least one high potency sweetener and the at least one anti-foaming agent; or
sequentially following the mixing of the at least one high potency sweetener and the at least one anti-foaming agent, wherein
the flavour enhancer is a high potency sweetener used in an amount below its sweetness threshold.
